(19) United States
(12) Patent Application Publication
(10) Pub. No.: US 2009/0129497 A1
(43) Pub. Date: May 21, 2009

(54) METHOD, DEVICE AND SYSTEM OF MULTI-INPUT-MULTI-OUTPUT WIRELESS COMMUNICATION

(76) Inventors: Daniel STOPLER, Holon (IL); Meir FEDER, Herzliya (IL)

Correspondence Address: EMPK & Shiloh, LLP;c/o Landon IP, Inc., 1700 Diagonal Road, Suite 450, Alexandria, VA, 22314, US

(21) Appl. No.: 12/344,622

(22) Filed: Dec. 29, 2008

Related U.S. Application Data
(63) Continuation-in-part of application No. PCT/IL2007/000779, filed on Jun. 26, 2007.
(60) Provisional application No. 61/117,260, filed on Nov. 24, 2008.

(51) Int. Cl. H04L 27/28

(52) U.S. Cl. 375/267

(57) ABSTRACT

Some demonstrative embodiments include devices, systems and/or methods of Multiple-Input-Multiple-Output wireless transmission. One embodiment may include a receiver to receive a wireless transmission via a plurality of receive antennas, and to generate an output including data based on the received wireless transmission, the receiver including a decoder to decode symbols of at least one frequency bin based on at least first and second antenna permutations applied to at least one channel response corresponding to the frequency bin; a correction-step determination module to determine at least first and second correction steps corresponding to the at least first and second antenna permutations, respectively, based on decision errors of decisions corresponding to the decoded symbols; and a channel adaptation module to update the channel response based on the correction steps. Other embodiments are described and claimed.

### CROSS-REFERENCE

This application claims the benefit of U.S. Provisional Patent application 61/117,260, entitled “Device, system, and method of Multiple-Input-Multiple-Output (MIMO) wireless communication”, filed Nov. 24, 2008; and is a Continuation-In-Part of International Application PCT/IL2007/000779, designating the United States, entitled “Method, device and system of multi-input-multi-output wireless communication”, filed Jun. 26, 2007, which claims the benefit of U.S. patent application Ser. No. 11/426,898, entitled “A high diversity time-space coding and decoding for MIMO”, filed Jun. 27, 2006, the entire disclosures of all of which are incorporated herein by reference.

### FIELD

Some embodiments relate generally to the filed of wireless communication and, more particularly, to Multi-Input-Multi-Output (MIMO) wireless communication.

### BACKGROUND

Wireless communication has rapidly evolved over the past decades. Even today, when high performance and high bandwidth wireless communication equipment is made available there is demand for even higher performance at a higher bandwidth.

In a Multi-Input-Multi-Output (MIMO) system may be subject to time-varying multi-path fading, in which a transmitted signal propagates along multiple paths to a receiver causing fading of the received signal. There are several techniques for reducing the Multi-path fading, such as time interleaving with error correction coding, implementation of frequency diversity by use of spread spectrum techniques, transmitter power control techniques, receiving antenna diversity, transmitting antenna diversity, or combinations thereof. Each technique has its own advantages and disadvantages.

A coding scheme for transmit diversity in a communication system implementing two transmission antennas and M reception antennas (2×M MIMO system), was proposed in “A Simple Transmit Diversity Technique for Wireless Communication”, Alamouti, S. M., IEEE Journal on Select Areas in Communications, Vol. 16, No. 8, pp. 1551-1458 (October 1998), for a case of two transmit antennas (the “Alamouti coding scheme”). The Alamouti coding scheme offers, in case of a single receiving antenna, second order diversity for complex valued signals. The Alamouti coding scheme includes simultaneous transmission of two signals from two antennas. In the Alamouti coding scheme, a pair of symbols is transmitted twice, in two consecutive time symbols and in either space or frequency domain. FIG. 1 illustrates encoding of symbols according to the Alamouti coding scheme. During a first symbol period, a signal S0 is transmitted from a first antenna and a signal S2 is transmitted from a second antenna. In a following symbol period, the first antenna transmits a signal −S1*, while the second antenna transmits a signal S0*, wherein S0* and S1* denote complex conjugates of S0 and S1, respectively. The Alamouti coding scheme assumes invariant channels between any two transmission periods, and that the channel is known to the receiver.

One advantage of the Alamouti coding scheme may be related to the fact that it allows an easy maximum-likelihood (ML) decoder implementation. The ML decoder is a good decoder with respect to minimum error probability. However, the Alamouti coding scheme is generally limited to the use of two transmission antennas, and to a rate of “1”, since, for example, only one independent signal per time unit may be transmitted.

Several methods to extend the Alamouti coding scheme have been suggested, for example, as described by U.S. Pat. No. 6,816,557 to Kuchi et al.

### SUMMARY

Some demonstrative embodiments may enable MIMO transmissions using more than two antennas, and/or a MIMO transmission rate higher than one.

Some embodiments include a wireless communication system including a receiver to receive a wireless transmission via a plurality of receive antennas, and to generate an output including data based on the received wireless transmission. The receiver may include a decoder to decode symbols of at least one frequency bin based on at least first and second antenna permutations applied to at least one channel response corresponding to the frequency bin; a correction-step determination module to determine at least first and second correction steps corresponding to the at least first and second antenna permutations, respectively, based on decision errors of decisions corresponding to the decoded symbols; and a channel adaptation module to update the channel response based on the correction steps.

In some embodiments, the receiver may include a memory to store a plurality of channel responses corresponding to a plurality of frequency bins, respectively; and a permutation module to determine, for the at least one frequency bin, at least first and second permuted channel responses, by permuting the channel response corresponding to the frequency bin according to the at least first and second antenna permutations, respectively, wherein the decoder is to decode the symbols of the frequency bin based on the permuted channel matrices.

In some embodiments, the correction steps are inversely proportional to a means square error of the decisions.

In some embodiments, the receiver is to determine input prediction errors based on the channel response and the decisions, and wherein the channel adaptation module is to update the channel response based on the correction steps and the input prediction errors.

In some embodiments, the wireless transmission includes a channel-tracking-pilotless transmission.

In some embodiments, the transmission includes symbols of two or more space-time block-encoded streams transmitted via a sequentially permuted set of two or more respective transmit antennas of a plurality of transmit antennas. During at least first and second consecutive time periods the permuted set of transmit antennas includes at least first and second respective different sets of two or more transmit antennas.

Some embodiments include a method of performing MIMO wireless communication. The method may include transmitting a wireless transmission, which does not include channel-tracking-pilot symbols, via a plurality of transmit antennas, wherein transmitting the transmission includes transmitting symbols of two or more space-time block-encoded streams via a sequentially permuted set of two or more respective transmit antennas of the plurality of transmit antennas, and wherein during at least first and second consecutive time periods the permuted set of transmit antennas includes at least first and second respective different sets of two or more transmit antennas.

In some embodiments, the method may include generating the two or more space-time block-encoded streams by encoding data symbols according to a base space-time block-coding scheme; and applying a sequence of at least first and second antenna permutations to permute the symbols of the two or more space-time block-encoded symbol streams to the at least first and second different sets of two or more transmit antennas.

In some embodiments, the method may include receiving the wireless transmission via a plurality of receive antennas; and generating an output including data based on the wireless transmission.

In some embodiments, the method may include decoding symbols of at least one frequency bin based on at least first and second antenna permutations applied to at least one channel response corresponding to the frequency bin.

In some embodiments, the method may include determining a plurality of channel responses corresponding to a plurality of frequency bins, respectively, based on the received wireless transmission; and for the at least one frequency bin, determining at least first and second permuted channel responses by permuting the channel response corresponding to the frequency bin according to the at least first and second antenna permutations, respectively. Decoding the symbols includes decoding the symbols of the frequency bin based on the permuted channel matrices.

In some embodiments, the method may include determining at least first and second correction steps corresponding to the at least first and second antenna permutations, respectively, based on decision errors of decisions corresponding to the decoded symbols; and updating the channel response based on the correction steps.

In some embodiments, the correction steps are inversely proportional to a means square error of the decisions.

In some embodiments, the method may include determining input prediction errors based on the channel response and the decisions; and updating the channel response based on the correction steps and the input prediction errors.

In some embodiments, the two or more space-time block-encoded streams include a plurality of pairs of space-time block-encoded streams, wherein the plurality of pairs of space-time block-encoded streams represent a plurality of different pairs of symbols, respectively, wherein during a first symbol time period each of the pairs of streams includes a first pair of symbols, respectively, and wherein during a second symbol time period each of the pairs of streams includes a second pair of symbols corresponding to complex conjugates of the first pair of symbols.

In some embodiments, during the symbol first time period first and second streams of a pair of the plurality of pairs of streams include first and second symbols, respectively, and during the second symbol time period the first and second streams include a negative conjugate of the second symbol and a conjugate of the first symbol, respectively.

In some embodiments, the plurality of transmit antennas include at least four transmit antennas.

In some embodiments, the at least first and second different sets of two or more transmit antennas include six different sets of four transmit antennas.

Some embodiments include a wireless communication system including a wireless transmitter to transmit a wireless transmission, which does not include channel-tracking pilot symbols, via a plurality of transmit antennas, wherein the transmission includes symbols of two or more space-time block-encoded streams transmitted via a sequentially permuted set of two or more respective transmit antennas of the plurality of transmit antennas, and wherein during at least first and second consecutive time periods the permuted set of transmit antennas includes at least first and second respective different sets of two or more transmit antennas.

In some embodiments, the transmitter includes a space-time block-encoder to generate the two or more space-time block-encoded streams by encoding data symbols according to a base space-time block-coding scheme; and an antenna permutation module to apply a sequence of at least first and second antenna permutations to permute the symbols of the two or more space-time block-encoded symbol streams to the at least first and second different sets of two or more transmit antennas.

In some embodiments, the system includes a receiver to receive the wireless transmission via a plurality of receive antennas, and to generate an output including data based on the wireless transmission.

In some embodiments, the receiver is to decode symbols of at least one frequency bin based on at least first and second antenna permutations applied to at least one channel response corresponding to the frequency bin.

In some embodiments, the receiver is to determine a plurality of channel responses corresponding to a plurality of frequency bins, respectively, based on the received wireless transmission; for the at least one frequency bin, to determine at least first and second permuted channel responses by permuting the channel response corresponding to the frequency bin according to the at least first and second antenna permutations, respectively; and to decode the symbols of the frequency bin based on the permuted channel matrices.

In some embodiments, the receiver includes a correction-step determination module to determine at least first and second correction steps corresponding to the at least first and second antenna permutations, respectively, based on decision errors of decisions corresponding to the decoded symbols; and a channel adaptation module to update the channel response based on the correction steps.

In some embodiments, the correction steps are inversely proportional to a means square error of the decisions.

In some embodiments, the receiver is to determine input prediction errors based on the channel response and the decisions, and wherein the channel adaptation module is to update the channel response based on the correction step and the input prediction errors.

In some embodiments, the two or more space-time block-encoded streams include a plurality of pairs of space-time block-encoded streams, wherein the plurality of pairs of space-time block-encoded streams represent a plurality of different pairs of symbols, respectively, wherein during a first symbol time period each of the pairs of streams includes a first pair of symbols, respectively, and wherein during a second symbol time period each of the pairs of streams includes a second pair of symbols corresponding to complex conjugates of the first pair of symbols.

In some embodiments, during the symbol first time period first and second streams of a pair of the plurality of pairs of streams include first and second symbols, respectively, and during the second symbol time period the first and second streams include a negative conjugate of the second symbol and a conjugate of the first symbol, respectively.

In some embodiments, the plurality of transmit antennas include at least four transmit antennas.

In some embodiments, the at least first and second different sets of two or more transmit antennas include six different sets of four transmit antennas.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. Moreover, some of the blocks depicted in the drawings may be combined into a single function. The figures are listed below.

FIG. 1 is a schematic illustration of an Alamouti coding scheme, as known in the art.

FIG. 2 is a schematic illustration of a wireless communication system, in accordance with some demonstrative embodiments.

FIG. 3 is a schematic illustration of a 4×M coding scheme, in accordance with some demonstrative embodiments.

FIG. 4 is a schematic flow-chart illustration of a method of transmitting a wireless transmission via a plurality of antennas, in accordance with some demonstrative embodiments.

FIG. 5 is a schematic illustration of a wireless transmitter, in accordance with some demonstrative embodiments.

FIG. 6 is a schematic illustration of a wireless receiver, in accordance with some demonstrative embodiments.

FIG. 7 is a schematic flow-chart illustration of a method of receiving a wireless transmission, in accordance with some demonstrative embodiments.

FIG. 8 is a schematic illustration of a decoding portion of a receiver, in accordance with some demonstrative embodiments.

FIG. 9A is a schematic illustration of a wireless transmitter, in accordance with some demonstrative embodiments.

FIG. 9B is a schematic illustration of a wireless transmitter, in accordance with some demonstrative embodiments.

FIG. 10 is a schematic illustration of a wireless receiver, in accordance with some demonstrative embodiments.

FIG. 11 is a schematic flow-chart illustration of a method wireless communication, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Some portions of the following detailed description are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities talce the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality” as used herein includes, for example, “multiple” or “two or more”. For example, “a plurality of items” includes two or more items.

Some embodiments may be used in conjunction with one or more types of wireless communication signals and/or systems, for example, Radio Frequency (RF), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, Multi-Carrier Modulation (MDM), Discrete Multi-Tone (DMT), Bluetooth (RTM), Global Positioning System (GPS), Wi-Fi, Wi-Max, ZigBee (TM), Global System for Mobile communication (GSM), 2G, 2.5G, 3G, 3.5G, or the like. Some embodiments may be used in various other devices, systems and/or networks.

Some embodiments are described herein with reference to OFDM communication. However, other embodiments may be implemented with respect to any other suitable modulation and/or wireless communication.

It should be understood that some embodiments may be used in a variety of applications. One or more of the methods, devices and/or systems disclosed herein may be used in many applications, e.g., civil applications, military applications or any other suitable application.

In some demonstrative embodiments the methods, devices and/or systems disclosed herein may be used in the field of consumer electronics, for example, as part of any suitable television, video Accessories, Digital-Versatile-Disc (DVD), multimedia projectors, Audio and/or Video (A/V) receivers/transmitters, gaming consoles, video cameras, video recorders, and/or automobile A/V accessories. In some demonstrative embodiments the methods, devices and/or systems disclosed herein may be used in the field of Personal Computers (PC), for example, as part of any suitable desktop PC, notebook PC, monitor, and/or PC accessories. In some demonstrative embodiments the methods, devices and/or systems disclosed herein may be used in the field of professional A/V, for example, as part of any suitable camera, video camera, and/or A/V accessories. In some demonstrative embodiments the methods, devices and/or systems disclosed herein may be used in the medical field, for example, as part of any suitable endoscopy device and/or system, medical video monitor, and/or medical accessories. In some demonstrative embodiments the methods, devices and/or systems disclosed herein may be used in the field of security and/or surveillance, for example, as part of any suitable security camera, and/or surveillance equipment. In some demonstrative embodiments the methods, devices and/or systems disclosed herein may be used in the fields of military, defense, digital signage, commercial displays, retail accessories, and/or any other suitable field or application.

One or more of the methods, devices and/or systems disclosed herein may be used to wirelessly transmit video signals, for example, High-Definition-Television (HDTV) signals, between at least one video source and at least one video destination. In other embodiments, the methods, devices and/or systems disclosed herein may be used to transmit, in addition to or instead of the video signals, any other suitable signals, for example, any suitable multimedia signals, e.g., audio signals, between any suitable multimedia source and/or destination.

Although some demonstrative embodiments are described herein with relation to wireless communication including video information, some embodiments may be implemented to perform wireless communication of any other suitable information or data. In one example, some embodiments may be implemented to perform wireless communication of multimedia information, e.g., audio information, in addition to or instead of the video information. Some embodiments may include, for example, a method, device and/or system of performing wireless communication of A/V information, e.g., including audio and/or video information. Accordingly, one or more of the devices, systems and/or methods described herein with relation to video information may be adapted to perform wireless communication of A/V information.

Some demonstrative embodiments may be implemented to perform diversity transmission using a number of transmission antennas greater than two, for example, four antennas. However, other embodiments may be implemented using any other suitable number of antennas, e.g., more or less than four antennas.

Some demonstrative embodiments may enable Multi-Input-Multi-Output (MIMO) transmissions using more than two antennas, and/or a MIMO transmission rate higher than one. In some non-limiting examples, the MIMO transmissions may have relatively high diversity, and/or stable ML decoding, e.g., for substantially all possible channel values.

In some demonstrative embodiments, an N×M coding scheme, wherein N≧4 and M≧2, e.g., N=4, may be applied to a transmission using N transmission antennas. In other embodiments, the N×M coding scheme may include any other suitable coding scheme, e.g., wherein N=2 or N=3.

In some demonstrative embodiments, according to the N×M coding scheme the N antennas may transmit in pairs such that, for example, each pair of antennas transmits a pair of respective blocks corresponding to a 2×M coding scheme, e.g., the Alamouti coding scheme, as described in detail below. The N×M coding scheme may increase a transmission rate, e.g., compared to the 2×M coding scheme. For example, the transmission of two signals at a given time slot may increase the transmission rate by a factor of two, e.g., compared to the Alamouti coding scheme.

Some demonstrative embodiments include a receiver, which may decode a transmission encoded according to the N×M coding scheme, for example, without performing matrix inversion and/or without significant noise enhancement. In some embodiments, improved stability to noise enhancement may be achieved by a simple, partial interference cancellation technique, that results in improved decoding performance, e.g., as described in detail below.

In some demonstrative embodiments, the N×M coding scheme may be applied in conjunction with an antenna permutation scheme to pair (group) a channel from an i-th transmit antenna to a j-th receive antenna with different channels, for example, for the purpose of data demodulation, e.g., as described below.

Some embodiments may include a communication system, e.g., including a wireless transmitter and/or wireless receiver, capable of performing pilotless wireless communication, e.g., as described below.

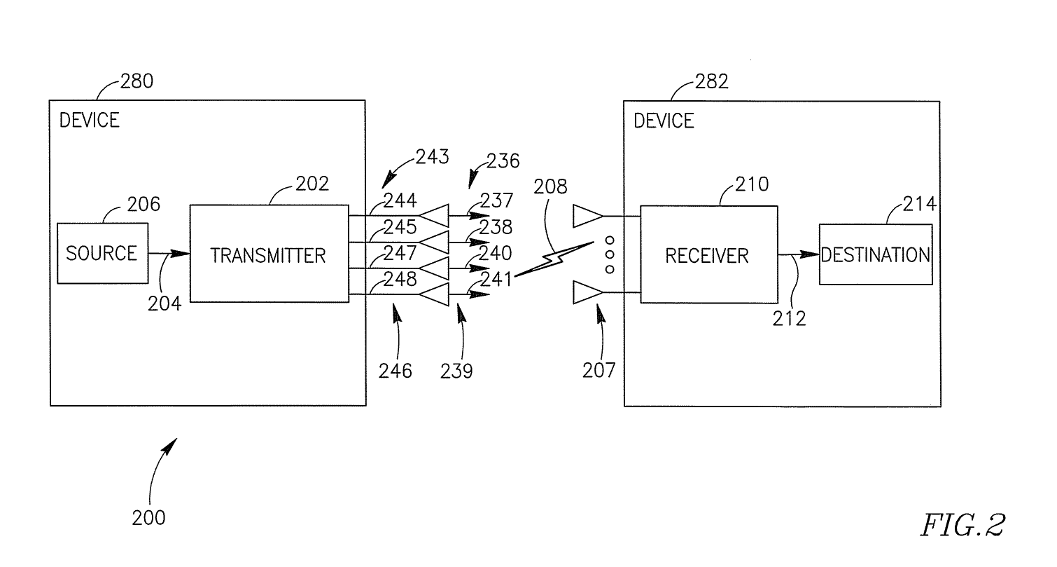

Reference is made to FIG. 2, which schematically illustrates a MIMO wireless communication system 200, in accordance with some demonstrative embodiments.

In some demonstrative embodiments, system 200 may include a wireless transmitter 202 capable of performing wireless communications, over a wireless communication channel, with a wireless receiver 210, e.g., as described in detail below.

In some embodiments, wireless transmitter 202 may transmit a wireless transmission 208 via a plurality of N antennas. For example, transmitter 202 may include four antennas 244, 245, 247 and 248, if N=4. Wireless transmission 208 may include a MIMO transmission. Wireless transmission 208 may include any suitable RF signals, blocks, frames, transmission streams, packets, video frames, control signals, messages and/or data, e.g., as described below.

In some demonstrative embodiments, transmitter 202 may generate transmission 208 by encoding data signals 204, which may be received from a source module 206, according to a N×M coding scheme (also referred to as the “space-time code”), e.g., as described in detail below.

In some embodiments, receiver 210 may have M antennas 207 to receive transmission 208. Receiver 210 may decode transmission 208 to generate decoded signals 212, e.g., corresponding to signals 204, which may be provided to a destination module 214.

In some embodiments, source module 206 and transmitter 202 may be implemented as part of a device 280; and/or destination module 214 and receiver 210 may be implemented as part of a device 282.

In some demonstrative embodiments, devices 280 and/or 282 may include any suitable portable device and/or non-portable device. In one example, devices 280 and/or 282 may include, may be, or may perform the functionality of a mobile device, e.g., a laptop, a Personal Digital Assistants (PDA), a handheld computer, a notebook computer, a portable game console, a Voice-Over-Internet-Prototcol (VoIP) phone, a portable video device, a portable computer, a video camera, a mobile phone, a portable television (TV) tuner, a photo viewer, a media player, a portable video player, a portable DVD player, and/or an MP-4 player. In another example, devices 280 and/or 282 may include, may be, or may perform the functionality of a non-portable device, e.g., a desktop computer, a non-portable computer, a workstation, a non-portable video source, a Set-Top-Box (STB), a DVD, a digital-video-recorder, a non-portable game console, a PC, a Video Cassette Recorder (VCR), a non-portable television (TV) tuner, a non-portable media player, a non-portable video player, a portable-video-player, a DVD player, an MP-4 player, a Bluray (BR) disk player, a video dongle, and the like.

In some demonstrative embodiments, devices 280 and/or 282, source 206 and/or destination 214 may include any suitable processor, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller; an input, for example, , for example, a keyboard, a keypad, a mouse, a touch-pad, a track-ball, a stylus, a microphone, or other suitable pointing device or input device; an output, for example, a monitor, a screen, a Cathode Ray Tube (CRT) display unit, a Liquid Crystal Display (LCD) display unit, a plasma display unit, one or more audio speakers, or other suitable output devices; a memory, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units; a storage, for example, a hard disk drive, a floppy disk drive, a Compact Disk (CD) drive, a CD-ROM drive, a DVD drive, or other suitable removable or non-removable storage units; and/or any other suitable hardware components and/or software components.

In some embodiments, source module 206 may include a suitable processor to generate data signals 204 and/or a suitable memory to store data signals 204 prior to transmission. Destination module 214 may include a suitable processor to process data signals 212 and/or a suitable memory to store data signals 212.

In some demonstrative embodiments, some or all of the components of devices 280 and/or 282 may be enclosed in a common housing, packaging, or the like, and may be interconnected or operably associated using one or more wired or wireless links. In other embodiments, components of devices 280 and/or 282 may be distributed among multiple or separate devices.

In some demonstrative embodiments, signals 204 may include video signals in any suitable video format. In one example, signals 204 may include HDTV video signals, for example, uncompressed HDTV signals, e.g., in a Digital Video Interface (DVI) format, a High Definition Multimedia Interface (HDMI) format, or any other suitable video format. According to these embodiments, source module 206 may include any suitable video source, for example, a set-top box, a computer, a game console, a Video Cassette Recorder (VCR), a Digital Video Disc (DVD), and the like. Destination module 214 may include, for example, a display or screen, e.g., a flat screen display, a Liquid Crystal Display (LCD), a plasma display, a television, and the like.

In some embodiments, transmitter 202 may apply a de-correlating transformation, e.g., a DCT and/or a wavelet, to signals 204, e.g., as described in U.S. patent application Ser. No. 11/551,641, entitled “Apparatus and method for uncompressed, wireless transmission of video”, filed Oct. 20, 2006, and published May 3, 2007, as US Patent Application Publication US 2007-0098063 (“the '641 Application”). For example, transmitter 202 may perform the DCT on a plurality of predefined blocks, wherein each block includes a block of 8×8 pixels, e.g., as described in the '641 Application. For example, transmitter 202 may perform the de-correlating transform on a plurality of color components, e.g., in the format Y-Cr-Cb, representing pixels of signals 204, as described in the '641 Application. In one embodiment, based on the DCT coefficients resulting from applying the DCT to the block of pixels (“the DCT block”), transmitter 202 may determine a plurality of values (“fine data”) to be mapped to a plurality of fine constellation symbols, and a plurality of values (“coarse data”) to be mapped to a plurality of coarse constellation symbols. The coarse data may include, for example, quantized DCT coefficients associated with low DCT frequencies, and the fine data may include, for example, the DCT coefficients associated with high frequencies and quantization errors of the quantized DCT coefficients. For example, the 8×8 block of pixels may be transformed into a DCT block of 192 coefficients, e.g., including three coefficients corresponding to each pixel; some of the coefficients (“coarsely-mapped coefficients”) may be mapped as coarse data, while the remaining coefficients (“finely coefficients”) as well as quantization errors of the coarsely-mapped coefficients may be mapped as fine data, e.g., as described in the '641 Application.

In other embodiments, signals 204 may include any other suitable signals, and/or source 206 and/or destination 214 may include any other modules to generate signals 204 of any suitable type or format. In one example, signals 204 may include audio, voice, and/or data signals.

In some embodiments, types of antennae that may be used for antennas 244, 245, 247, 248, and/or 207 may include but are not limited to internal antenna, dipole antenna, omni-directional antenna, a monopole antenna, an end fed antenna, a circularly polarized antenna, a micro-strip antenna, a diversity antenna and the like.

In some embodiments, transmitter 202 may transmit wireless transmission 208 including a plurality of pairs of first and second transmission streams, e.g., N/2 pairs of transmission streams, via a plurality of respective pairs of antennas, e.g., N/2 pair of antennas. For example, transmission 208 may include two pairs 236 and 239 of transmission streams, which may be transmitted by two respective pairs of antennas 243 and 210, e.g., if N=4. Transmission pair 236 may include transmission streams 237 and 238, which may be transmitted by antennas 244 and 245 of pair 243, respectively; and transmission pair 239 may include transmission streams 240 and 241, which may be transmitted by antennas 247 and 248 of pair 246, respectively.

In some demonstrative embodiments, the first and second transmission streams of a pair of the N/2 pairs of transmission streams may include first and second symbols, respectively, during a first time period, and first and second complex conjugates of the first and second symbols, during a second time period, as described in detail below. For example, stream pair 236 may include a first pair of symbols during a first time period, and a pair of complex conjugates of the first pair of symbols, during a second time period. Stream pair 239 may include a second pair of symbols, e.g., different than the first pair of symbols, during the first time period, and a pair of complex conjugates of the second pair of symbols, during the second time period.

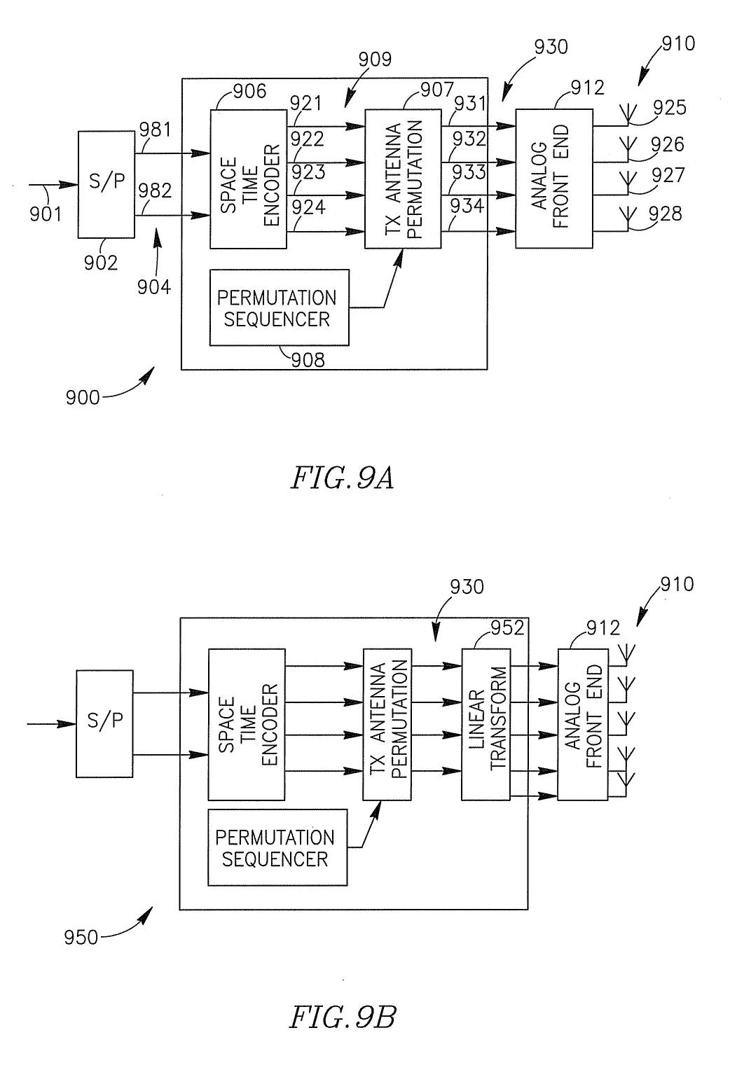

In some embodiments, transmitter 202 may apply to signals 204 the N×M space-time code in conjunction with an antenna permutation scheme. In one example, transmitter 202 may apply the antenna permutation scheme on top of a predefined base space-time block code (STBC), e.g., as described below with reference to FIGS. 9A and/or 9B.

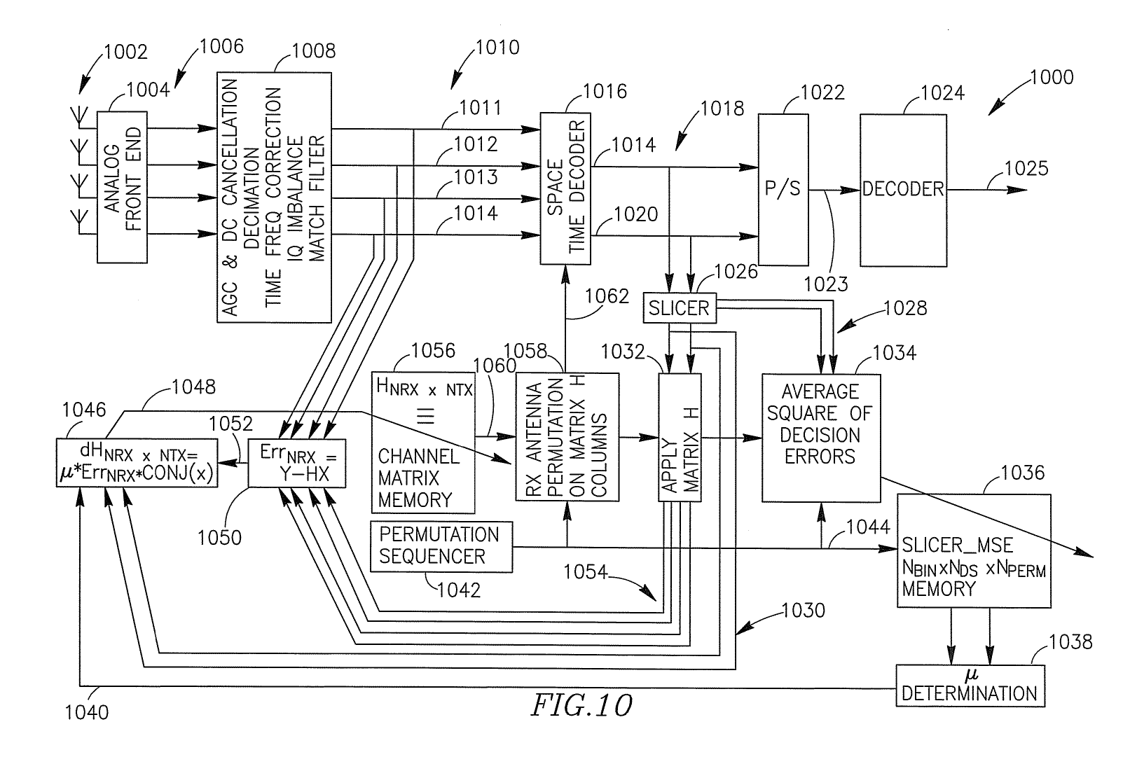

In some embodiments, one or more elements of system 200, e.g., transmitter 202 and/or receiver 210, may be adapted to perform decision-directed operation, e.g., as described below with reference to FIGS. 9A, 9B, 10 and/or 11.

Reference is now made to FIG. 3, which schematically illustrates a 4×M coding scheme, in accordance with some demonstrative embodiments. In one embodiment, the coding scheme of FIG. 3 may be implemented by one or more elements of system 200 (FIG. 2), e.g., by transmitter 202 (FIG. 2) and/or receiver 210 (FIG. 2). For example, transmitter 202 (FIG. 2) may encode signals 204 (FIG. 2) according to the coding scheme of FIG. 3, to generate transmission 208 (FIG. 2).

As shown in FIG. 3, In some demonstrative embodiments, the 4×M coding scheme may include a first pair of first and second transmit antennas, denoted ‘0’ and ‘1’, respectively, transmitting a first pair of symbols, denoted S0 and S1, respectively, during a first time period, denoted t. A second pair of antennas including first and second antennas, denoted ‘2’ and ‘3’, respectively, may transmit a second pair of symbols, denoted symbols S2 and S3, respectively, during the time period t. During a second time period, denoted t+T, e.g., immediately subsequent to the time period t, antenna ‘0’ may transmit a complex conjugate of symbol S1, e.g., a symbol −S1*, and antenna ‘1’ may transmit a complex conjugate of symbol S0, e.g., a symbol S0*, wherein “*” denotes a complex conjugate. During time period t+T, antennas ‘2’ and ‘3’ may transmit complex conjugates of symbols S3 and S2, respectively. For example, during time period t+T, antenna ‘2’ may transmit a symbol −S3*, and antenna ‘3’ may transmit a symbol S2*.

In some demonstrative embodiments, a transmission according to the coding scheme of FIG. 3 may be represented by a source matrix, denoted S, e.g., as follows:

$$S = [ \begin{matrix}{S}_{0} & - {S}_{1}^{*} \\ {S}_{1} & {S}_{0}^{*} \\ {S}_{2} & - {S}_{3}^{*} \\ {S}_{3} & {S}_{2}^{*}\end{matrix} ] \qquad ( 1 )$$

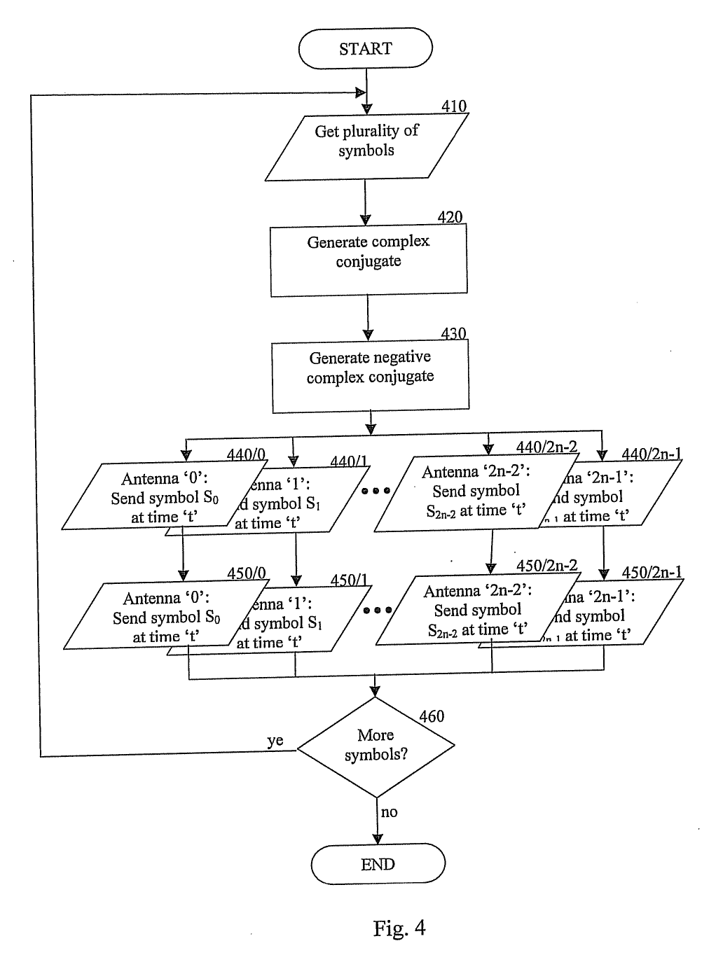

Reference is now made to FIG. 4, which schematically illustrates a method of transmitting a wireless transmission via a plurality of antennas, in accordance with some demonstrative embodiments. In one embodiment, one or more operations of the method of FIG. 4 may be implemented by a wireless transmitter, e.g., wireless transmitter 202 (FIG. 2), to transmit a wireless transmission, e.g., transmission 208 (FIG. 2).

As indicated at block 410, the method may include receiving a plurality, e.g., an even number greater than 2, of symbols to be transmitted. For example, the method may include receiving four symbols S0, S1, S2, and S3.

As indicated at block 420, the method may include determining complex conjugates of one or more of the received symbols, e.g., the even symbols. For example, the method may include calculating the conjugate symbols S0* and S2*.

As indicated at block 430, the method may also include determining negative complex conjugates of one or more of the received symbols, e.g., the odd symbols. For example the method may include calculating the symbols −S1* and −S3*.

As indicated at block 440, the method may include transmitting the plurality of received symbols over a plurality of antennas, respectively, during a first time period. For example, symbols S0, S1, S2, and S3 may be transmitted during time period t by antennas ‘0’, ‘1’, ‘2’, and ‘3’, respectively, e.g., substantially in parallel.

As indicated at block 450, the method may also include transmitting the conjugate symbols during a second time period, e.g., immediately subsequent to the first time period. For example, symbols −S1*, S0*, −S3*, and S2* may be transmitted during time period t+T by antennas ‘0’, ‘1’, ‘2’, and ‘3’, respectively, e.g., substantially in parallel.

As indicated at block 460, the method may include determining if more symbols are to be transmitted. The method may include repeating one or more of the operations described above with reference to blocks 410, 420, 430, 440 and 450 to transmit additional symbols.

Although some demonstrative embodiments are described herein with reference to using a 4×M coding scheme for transmitting a transmission via four transmission antennas, other embodiments may be implemented for performing a wireless transmission using more than four transmission antennas, e.g., any suitable even number of antennas.

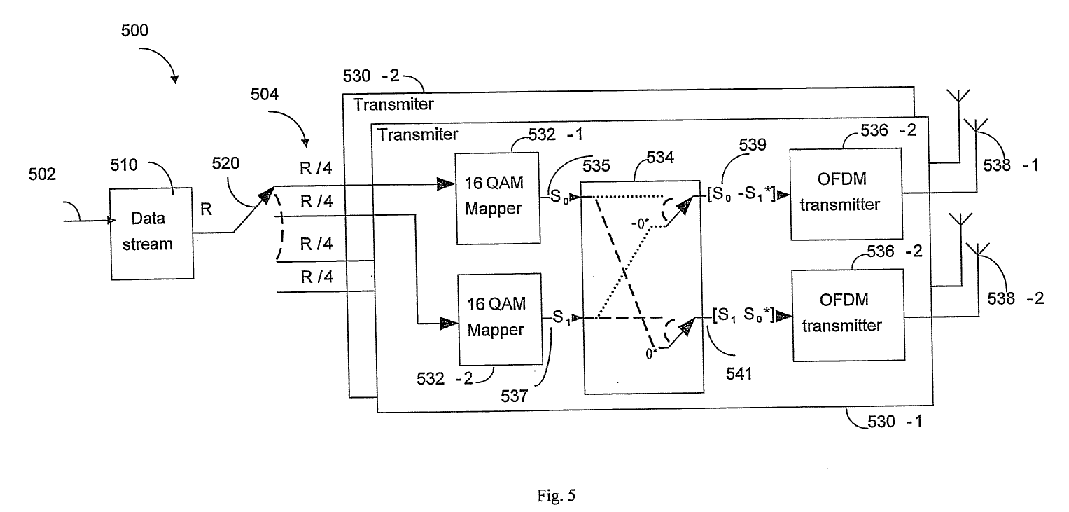

Reference is made to FIG. 5, which schematically illustrates a wireless transmitter 500, in accordance with some demonstrative embodiments. In one demonstrative embodiment, transmitter 500 may perform the functionality of transmitter 202 (FIG. 2).

In some demonstrative embodiments, transmitter 500 may include a data streamer 510 to provide a stream of input symbols 502 symbols at a rate, denoted R. Transmitter 500 may also include a selector 520 to route the symbols to four input channels 504, e.g., at a rate of R/4 per channel.

In some demonstrative embodiments, transmitter 500 may also include a first transmission module 530-1 to receive as an input a first pair of channels 504, corresponding to symbols S0 and S1; and a second transmission module 530-2 to receive as an input a second pair of channels 504, corresponding to symbols S2 and S3.

In some demonstrative embodiments, transmission modules 530-1 and 530-2 may include two identical transmitters, e.g., two Alamouti transmitters.

In some demonstrative embodiments, transmission module 530-1 may include mappers 532-1 and 532-2 to map symbols S0 and S1, respectively. For example, mappers 532-1 and 532-2 may include any suitable Quadrature-Amplitude-Modulation (QAM) mappers of any suitable constellation, e.g., 16 QAM.

In some demonstrative embodiments, transmission module 530-1 may also include a coder 534 having inputs 535 and 537 to receive outputs of mappers 532-1 and 532-2, respectively. Coder 534 may generate first and second output streams 539 and 541, based on symbols received at inputs 535 and 537. For example, during a first time period, e.g., the time period t, coder 534 may provide at outputs 539 and 541 two symbols received via inputs 535 and 537, e.g., symbols S0 and S1, respectively. During a second time period, e.g., time period t+T, coder 534 may provide the complex conjugate of the symbol from input 535, for example S0*, at output 541; and the negative complex conjugate of the symbol from input 537, for example −S1*, at output 539.

In some demonstrative embodiments, transmission module 530-1 may also include two Orthogonal-frequency-Division-Multiplexing (OFDM) transmitters 536-1 and 536-2 to transmit symbols received from outputs 539 and 541, respectively, over antennas 538-1 and 538-2, respectively. For example, OFDM transmitter 536-1 may transmit over antenna 538-1 a sequence of symbols including the symbol S0 followed by the symbol −S1*, during the first and second time periods, respectively; and OFDM transmitter 536-2 may transmit over antenna 538-2 a sequence of symbols including the symbol S1 followed by the symbol S0*, during the first and second time periods, respectively.

Although some demonstrative embodiments are described herein with reference to a transmitter, e.g., transmitter 500, including two transmission modules, e.g., transmission modules 530-1 and 530-2, to transmit a transmission via four transmission antennas, in other embodiments the transmitter may include more than two transmission modules to transmit a transmission via more than four antennas.

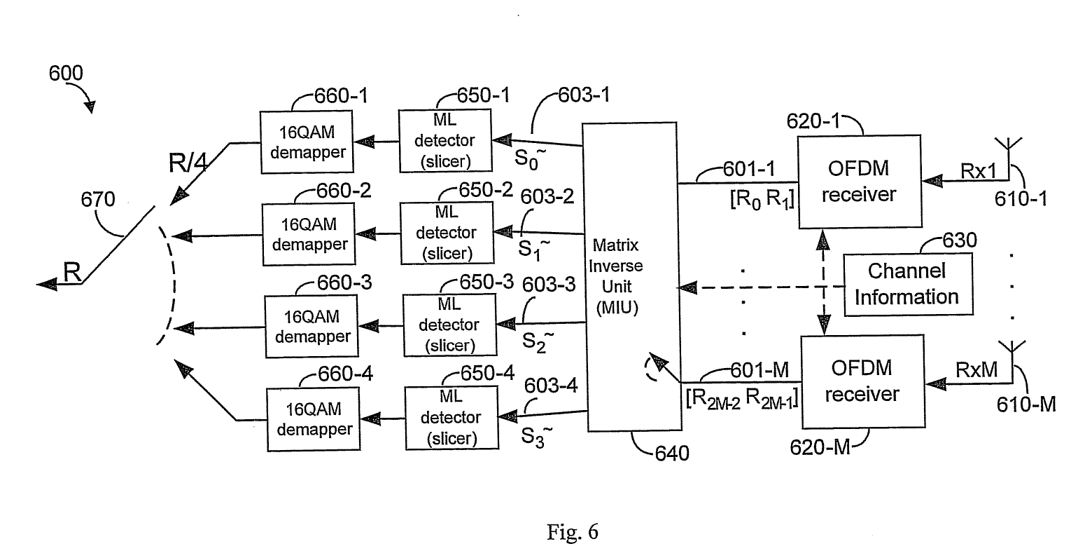

Reference is now made to FIG. 6, which schematically illustrates a wireless receiver 600, in accordance with some demonstrative embodiments. In one demonstrative embodiment, receiver 600 may perform the functionality of receiver 210 (FIG. 2).

In some demonstrative embodiments, receiver 600 may include M wireless receiver modules, for example, OFDM receivers 620-1 . . . 620-M, to receive a wireless transmission over M receive antennas 610-1 . . . 610-M, respectively. The wireless transmission may include symbols encoded according to an N×M coding scheme, e.g., the 4×M coding described above with reference to FIG. 3. For example, receiver 600 may receive the transmission of symbols S0, S1, S2 and S3, transmitted by transmitter 500 (FIG. 5) during the time periods t and t+T.

In some demonstrative embodiments, receiver 600 may also include a plurality of Matrix Inverse Units (MIUs) 640. Each MIU 640 may be associated with a respective OFDM bin of receivers 620, to generate N symbols, e.g., four symbols 603-1, 603-2, 603-3, and 603-4, based on M symbol streams 601-1 . . . 601-M received from receivers 620, e.g., as described in detail below. Receiver 600 may also include a channel information module 630 to provide channel information to OFDM receivers 620, and/or MIU 640, e.g., as described below.

In some demonstrative embodiments, receiver 600 may also include a plurality of detectors to perform detection operations on the symbols generated by MIU 640, as described in detail below. For example, receiver 600 may include Most-Likelihood (ML) detectors 650-1, 650-2, 650-3, and 650-4, to perform detection operations on symbols 603-1, 603-2, 603-3, and 603-4, respectively. In some demonstrative embodiments, one or more of detectors 650-1, 650-2, 650-3, and 650-4 may include a slicer, e.g., as described in detail below.

In some demonstrative embodiments, receiver 600 may also include a plurality of demappers to demap outputs of the plurality of detectors, respectively. For example, receiver 600 may include demappers 660-1, 660-2, 660-3, and 660-4, to demap outputs of detectors 650-1, 650-2, 650-3, and 650-4, respectively. One or more characteristics of the demappers may depend on a constellation of the transmission to be received by receiver 600. For example, demappers 660-1, 660-2, 660-3, and/or 660-4 may include 16-QAM demappers, e.g., if receiver 600 is to receive 16 QAM transmissions.

In some demonstrative embodiments, receiver 600 may also include an output selector 670 to selectively transfer symbols output by demappers 660-1, 660-2, 660-3, and/or 660-4, e.g., at a rate R/4, as a stream of symbols at the rate of R.

In some demonstrative embodiments, MIU 640 may perform matrix inversion without using extensive computing power and/or without generating noise amplification, e.g., as described below.

Some demonstrative embodiments are described below with relation to performing operations on a received transmission, which may be encoded using the 4×M coding scheme represented by the source matrix S of Equation 1, as described above with reference to FIG. 3. However, other embodiments may be implemented to perform operations on a transmission encoded using any other N×M coding scheme represented by any other suitable source matrix S.

A receiver, for example, receiver 600, may have a plurality of receiving antennas, for example, M antennas 610-1 . . . 610-M. Accordingly, at each bin, a wireless channel over which the wireless transmission is received may be identified by a matrix, denoted H, having M rows and N columns. For example, if N=4 and M=2, then the matrix H may be represented as follows:

$$H = [ \begin{matrix}{h}_{11} & {h}_{21} & {h}_{31} & {h}_{41} \\ {h}_{12} & {h}_{22} & {h}_{32} & {h}_{42}\end{matrix} ] \qquad ( 2 )$$

The M=2 receive antennas may receive two adjacent received signals, which may be represented, for example, as follows:

R=HS+N (3)

wherein R denotes a matrix representing the received signal from the M antennas of a specific OFDM bin over two subsequent time periods, for example, ‘t’ and ‘t+T’, e.g., as follows:

$$R = [ \begin{matrix}{r}_{0} & {r}_{1} \\ {r}_{2} & {r}_{3} \\ ⋮ & ⋮ \\ {r}_{2 M - 2} & {r}_{2 M - 1}\end{matrix} ] \qquad ( 4 )$$

wherein even and odd indexed signals of the matrix R correspond to the time periods t and t+T, respectively, and wherein N denotes a matrix of spatially and temporally uncorrelated Additive White Gaussian Noise (AWGN), e.g., for each of the received channels. For example, the noise matrix N for two subsequent time periods, e.g., the time periods t and t+T, may be represented as follows:

$$N = [ \begin{matrix}{n}_{0} & {n}_{1} \\ {n}_{2} & {n}_{3} \\ ⋮ & ⋮ \\ {n}_{2 M - 2} & {n}_{2 M - 1}\end{matrix} ] \qquad ( 5 )$$

The two adjacent received signals may be presented as a linear transformation of the two adjacent transmitted symbols, e.g., by reshaping the received signals matrix of Equation 3 into a vector form, as follows:

r=H*s+n (6)

wherein:

$$\begin{matrix}r = {[ {r}_{0} , {r}_{1}^{*} , {r}_{2} , {r}_{3}^{*} , … , {r}_{2 M - 2} , {r}_{2 M - 1}^{*} ]}^{T} & ( 7 ) \\ n = {[ {n}_{0} , {n}_{1}^{*} , {n}_{2} , {n}_{3}^{*} , … , {n}_{2 M - 1} ]}^{T} , s = {[ {s}_{0} , {s}_{1} , {s}_{2} , {s}_{3} ]}^{T} & ( 8 ) \\ H = [ \begin{matrix}{h}_{11} & {h}_{12} & {h}_{13} & {h}_{14} \\ {h}_{12}^{*} & - {h}_{11}^{*} & {h}_{14}^{*} & - {h}_{13}^{*} \\ ⋮ & ⋮ & ⋮ & ⋮ \\ {h}_{M1} & {h}_{M2} & {h}_{M3} & {h}_{M4} \\ {h}_{M2}^{*} & - {h}_{M1}^{*} & {h}_{M4}^{*} & - {h}_{M3}^{*}\end{matrix} ] & ( 9 )\end{matrix}$$

wherein n may include, for example, a white noise vector, e.g.:

Cov(n)=σ²I (10)

A system (“the 2×M system”) implementing a 2×M Alamouti encoding scheme is limited to two transmission antennas, and has M reception antennas. In the 2×M system the channel matrix H is known to be an orthogonal matrix for any channel realization. Accordingly, multiplying r from the right by H^{T}, wherein H^{T} denotes the conjugate transposed matrix of H, may leave the AWGNs spatially uncorrelated. Therefore extraction of the transmitted symbols may be performed separately, for example, using a simple decoder that works on each signal separately, e.g., without losing any optimality. Conversely, the matrix H^{T}H, corresponding to the N×M coding scheme may not result in spatially uncorrelated AWGNs. However, In some demonstrative embodiments, the product H^{T}H, corresponding to the N×M coding scheme, may include a four-by-four matrix, e.g., as follows:

$$( {H}^{T} H ) = {[ \begin{matrix}{\vert a \vert}^{2} {I}_{2} & C \\ {C}^{*} & {\vert b \vert}^{2} {I}_{2}\end{matrix} ]}_{4 4} \qquad ( 11 )$$

In some demonstrative embodiments, each two-by-two sub-matrix of the four-by-four matrix of Equation 11 may have the following characteristics:

$$\begin{matrix}C = [ \begin{matrix}α & β \\ - {β}^{*} & {α}^{*}\end{matrix} ] & ( 12 ) \\ {\vert a \vert}^{2} = {\sum }_{m = 1}^{M} [ {\vert {h}_{m , 1} \vert}^{2} + {\vert {h}_{m , 2} \vert}^{2} ] & ( 13 ) \\ {\vert b \vert}^{2} = {\sum }_{m = 1}^{M} [ {\vert {h}_{m , 3} \vert}^{2} + {\vert {h}_{m , 4} \vert}^{2} ] & ( 14 ) \\ α = {\sum }_{m = 1}^{M} [ {h}_{m , 1}^{*} {h}_{m , 3} + {h}_{m , 2} {h}_{m , 4}^{*} ] & ( 15 ) \\ β = {\sum }_{m = 1}^{M} [ {h}_{m , 1}^{*} {h}_{m , 4} - {h}_{m , 2} {h}_{m , 3}^{*} ] & ( 16 )\end{matrix}$$

In some demonstrative embodiments, sub-matrices in the first and fourth quadrants of the matrix H^{T}H may be diagonal matrices, e.g., including a product of a constant and the unity matrix. The sub-matrices in the second and third quadrants of the matrix H^{T}H may be orthogonal to one another, e.g., for any possible H.

According to one demonstrative embodiment, the matrix H may be updated, e.g., periodically, to account, for example, for variations in transmission conditions. In one example, the matrix H may be periodically updated during a vertical blanking period of a video stream, e.g., as described in U.S. patent application Ser. No. 11/619,810, entitled “Method and apparatus for using the video blanking period for the maintenance of a modem that is used for wireless transmission of video”, filed Jan. 4, 2007. In another example, the matrix H may be updated, e.g., at a relatively high frequency, for example, using pilot signals and/or based on previously decoded symbols, as described in U.S. patent application Ser. No. 11/551,641, entitled “Apparatus and method for uncompressed, wireless transmission of video”, filed Oct. 20, 2006, and published May 3, 2007, as Application Publication US2007-0098063; and U.S. patent application Ser No. 11/621,919, entitled “Use of pilot symbols for data transmission in uncompressed, wireless transmission of video”.

In some demonstrative embodiments, implementing extraction of transmitted symbols from the received symbols may be straightforward and/or relatively simple, for example, without inversion of matrices, e.g., if Equations 12, 13, 14, 15, and/or 16 are used. In one non-limiting example, the following equations may be used if, for example, M=2 and N=4:

|a|²=|h₁₁|²+|h₂₁|²+|h₁₂|²+|h₂₂|² (17)

|b|²=|h₃₁|²+|h₄₁|²+|h₃₂|²+|h₄₂|² (18)

α=h*₁₁h₁₃+h₁₂h*₁₄+h*₂₁h₂₃+h₂₂h*₂₄ (19)

β=h*₁₁h₁₄−h₁₂h*₁₃+h*₂₁h₂₄−h₂₂h*₂₃ (20)

In some demonstrative embodiments, the values of α and β may be interpreted as cross-correlation.

According to some demonstrative embodiments, a matrix W orthogonal to the matrix H^{T}H may be defined as follows:

$$W = {[ \begin{matrix}{\vert b \vert}^{2} {I}_{2} & - C \\ - {C}^{* T} & {\vert a \vert}^{2} {I}_{2}\end{matrix} ]}_{4 4} \qquad ( 21 )$$

The matrix W may have structure similar to the structure of the matrix H^{T}H. For example, the matrix W may include two sub-matrices that are diagonal, e.g., along a primary diagonal of matrix W, and two sub-matrices that are orthogonal, e.g., along a secondary diagonal of matrix W. Matrices H and W may depend on parameters of the receive channel, as discussed herein.

In some demonstrative embodiments, the received signal of the M receive antennas may be multiplied by the transposed matrix H^{T}, e.g., as follows:

\hat{r}=H^{T}r=H^{T}Hs+H^{T}n (22)

In some demonstrative embodiments, the matrix W is the inverse matrix of the matrix H^{T}H. Accordingly, Equation 22 may be multiplied by the matrix W, e.g., as follows:

r=W\hat{r}=WH^{T}Hs+WH^{T}n=s+WH^{T}n (23)

In some demonstrative embodiments, the received wireless transmission may be decoded, e.g., as described above. Accordingly, the wireless transmission may be handled without, for example, performing matrix-inversion operations, which in turn may result in noise enhancement.

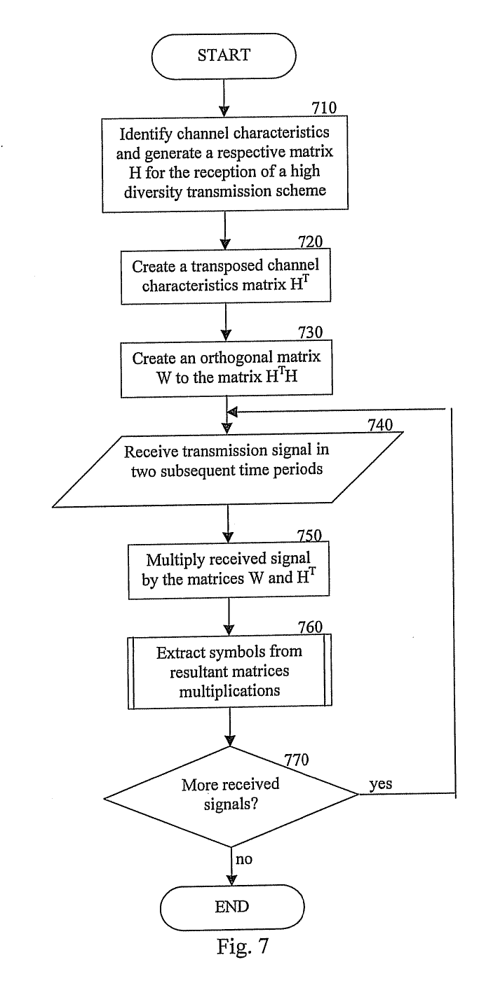

Reference is now made to FIG. 7, which schematically illustrates a method of receiving a wireless transmission, in accordance with some demonstrative embodiments. In one demonstrative embodiment, one or more operations of the method of FIG. 7 may be implemented by a receiver, e.g., receiver 600 (FIG. 6), to receive a wireless transmission over a wireless channel.

As indicated at block 710, the method may include identifying channel characteristics of the receive channel. For example, the matrix H representative of the channel characteristics may be determined, e.g., as described above.

As indicated at block 720, the method may include determining the transposed matrix H^{T} of the matrix H. If the matrix H is an N×M matrix, as described above, then an element H^{T}[i, j] of the matrix H^{T} may be determined by H^{T}[i, j]=H[j, i ] wherein 1<i<n and 1<j<m. Accordingly, the operation of determining the matrix H^{T} based on the matrix H, may be straightforward, e.g., without involving the use of an inverse operation.

As indicated at block 730, the method may include determining the matrix W, e.g., based on the matrices H and H^{T}. For example, the matrix W may be determined as an orthogonal matrix to the matrix H^{T}H, as described above.

In some demonstrative embodiments, the matrix W may be directly determined in accordance with Equations, 12-16 and 21, as described above. Accordingly, the operation of determining the matrix W may be straightforward, e.g., without involving the use of an inverse operation.

As indicated at block 740, the method may include receiving during two time periods a sequence of two, e.g., consecutive, signals of a diversity transmission encoded according to an N×M encoding scheme, e.g., as described above. For example, the method may include receiving a sequence of two signals of the transmission during the time periods t and t+T, as described above.

As indicated at block 750, the method may include multiplying the received signal by the matrices H^{T} and W. For example, the received signal may be multiplied first by the matrix H^{T}, and the product of the multiplication may be multiplied by the matrix W, e.g., in accordance with Equations 22 and 23.

As indicated at block 760, the method may include extracting the transmitted symbols, e.g., as described in detail below.

As indicated at block 770, the method may include determining whether additional signals are to be received. The method may include repeating the operations of blocks 740, 750, 750, 760, and 770, e.g., if additional signals are received.

According to some demonstrative embodiments, the methods, devices and/or systems described herein may enable encoding, transmitting, receiving, and/or decoding a wireless transmission for any suitable channel characteristic which, for example, may not necessarily be a predetermined characteristic. The encoding scheme described herein may be efficiently implemented by a MIMO system, e.g., system 200 (FIG. 2) since, for example, the encoding scheme may not require performing matrix inversion operations, which may be inefficient and/or may result in noise enhancement.

In some demonstrative embodiments, the inverse matrix (HTH)⁻¹ may be determined as follows:

$${( {H}^{T} H )}^{- 1} = \frac{1}{{\vert a \vert}^{2} {\vert b \vert}^{2} - ( {\vert α \vert}^{2} + {\vert β \vert}^{2} )} [ \begin{matrix}{\vert b \vert}^{2} {I}_{2} & - C \\ - {C}^{*} & {\vert a \vert}^{2} {I}_{2}\end{matrix} ] \qquad ( 24 )$$

In some demonstrative embodiments, the following may be true when the number of reception antennas M increases:

$$\frac{\vert {α}^{2} \vert + \vert {β}^{2} \vert}{\vert {a}^{2} \vert \vert {b}^{2} \vert} \to 0 \qquad ( 25 )$$

Accordingly, the matrix H may become more orthogonal as the number M increases. In some demonstrative embodiments, multiplying the received signal r by the pseudo-inverse of H, and then estimating the transmitted symbols by applying a ML decision rule on each transformed signal separately may be justified (the Zero-Forcing detector), especially for a large number M of receiving antennas. Such a detector is expected to become closer to the ML detector as the number M increases.

In some demonstrative embodiments, the extraction of the symbols from the received signals may include comparing the square absolute values |a|² and |b|². For example, it may be determined that the transmission of the symbols S0 and S1 has suffered less noise interference compared to the transmission of the symbols S2 and S3, e.g., if |b|² is smaller than |a|². It may be determined that the transmission of the symbols S2 and S3 has suffered less noise interference compared to the transmission of the symbols S0 and S1 if, for example, |a|² is smaller than |b|².

In some demonstrative embodiments, the pair that is determined to have suffered less noise interference may be selected for fall decoding and their influence on the received signals can then be removed from the received symbols. This may result, for example, in a standard Alamouti code for the other two components, which can now be easily extracted, e.g., as described in detail below. As a result, an efficient decoding of the pair of symbols that have suffered less noise interference and, after their removal, a higher diversity order may be achieved for the symbols that were more impacted by noise interference.

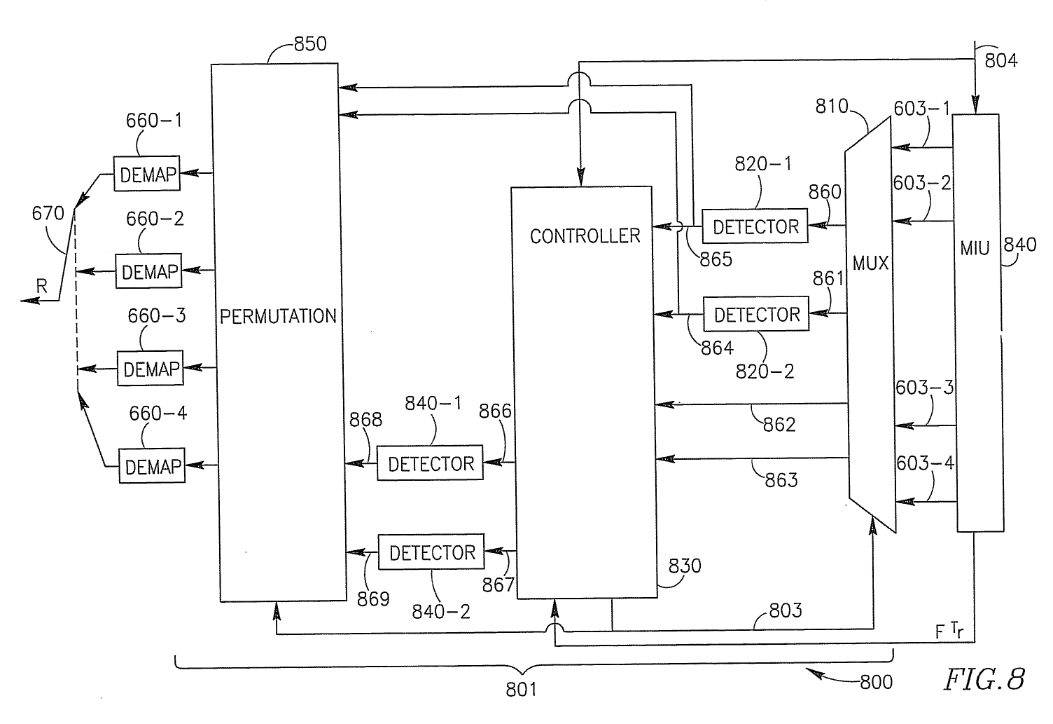

Reference is now made to FIG. 8, which schematically illustrates a portion of a receiver 800 including an interference cancellation decoder 801, in accordance with some demonstrative embodiments.

In one demonstrative embodiment, receiver 800 may include MIU 640, demappers 660-1, 660-2, 660-3, and 660-4, and/or selector 670, e.g., in analogy to receiver 600 as are described above with reference to FIG. 6. Receiver 800 may also include antennas 610, OFDM receivers 620, and channel information module 630 to provide channel information 804 (not shown in FIG. 8).

As described above with reference to FIG. 6, MIU 640 may provide an output including a plurality of an even number of symbols, for example, four symbols 603-1, 603-2, 603-3, and 603-4. In some demonstrative embodiments, decoder 801 may include a multiplexer 810 to select a set of symbols (“the selected set”) from a first set of two or more symbols of the plurality of the received symbols and a second set of two or more of the received symbols based, for example, on a predefined selection criterion. The selection criterion may relate, for example, to the sub-matrices of the primary diagonal of the matrix W, e.g., as described in detail below. For example, multiplexer 810 may select a pair of symbols (“the selected pair of symbols”) including either a first of symbols 603-1 and 603-2, e.g., including symbols S0 and S1, or a second pair of symbols 603-3 and 603-4, e.g., including symbols S2 and S3, e.g., if N=4. Multiplexer 810 may select the selected pair of symbols based, for example, on a control signal 803, e.g., as is described below. Multiplexer may provide symbols 860 and 861 including the selected pair of symbols, respectively. Multiplexer 810 may also provide symbols 862 and 863 including the pair of symbols, which was not selected (“the noisier pair”).

In some demonstrative embodiments, decoder 801 may also include a first set of two or more detectors to receive the two or more symbols, respectively, of the selected set of symbols. For example, decoder 801 may include ML detectors 820-1 and 820-2 to respectively receive the selected pair of symbols 860 and 861, and generate a pair of detected symbols 865 and 864 corresponding to the selected pair of selected, respectively. In some demonstrative embodiments, decoder 801 may also include a controller 830 to control multiplexer 810. For example, controller 830 may determine control signal 803 provided to multiplexer 810, based on channel information 804, e.g., as described below. Controller 830 may determine, for example, which of the first and second sets of received signals has suffered less noise interference, e.g., by comparing |b|² to |a|². If |b|² is less than |a|², then it may be determined that symbols S0 and S1 have been less impacted by noise. By contrast, if |a|² is less than |b|², then it may be determined that the symbols S2 and S3 have been less impacted by noise.

In some demonstrative embodiments, the noise covariance values, denoted Cov(n₀), Cov(n₁), Cov(n₂), and Cov(n₃), of the channels for receiving the symbols S0, S1, S2, and S3, respectively, may be determined as follows:

$$Cov ( {n}_{0} ) = Cov ( {n}_{1} ) = \frac{{σ}^{2} {\vert b \vert}^{2}}{{\vert a \vert}^{2} {\vert b \vert}^{2} - ( {\vert α \vert}^{2} + {\vert β \vert}^{2} )} = \frac{{σ}^{2}}{{\vert a \vert}^{2} ( 1 - \frac{{\vert α \vert}^{2} + {\vert β \vert}^{2}}{{\vert a \vert}^{2} {\vert b \vert}^{2}} )} \\ Cov ( {n}_{2} ) = Cov ( {n}_{3} ) = \frac{{σ}^{2} {\vert a \vert}^{2}}{{\vert a \vert}^{2} {\vert b \vert}^{2} - ( {\vert α \vert}^{2} + {\vert β \vert}^{2} )} = \frac{{σ}^{2}}{{\vert b \vert}^{2} ( 1 - \frac{{\vert α \vert}^{2} + {\vert β \vert}^{2}}{{\vert a \vert}^{2} {\vert b \vert}^{2}} )} \qquad ( 26 )$$

In some demonstrative embodiments, controller 830 may generate signal 803 as follows:

if |a|²>|b|² attain ŝ₀,ŝ₁ else attain ŝ₂,ŝ₃ (27)

In some demonstrative embodiments, controller 830 may generate a second pair of symbols 866 and 867 by subtracting the detected pair of symbols 864 and 865 from a linear transformation of the received signals \hat{r}, wherein \hat{r} may be determined, for example, from Equation 22. It can be shown that, for example:

$$\hat{r} = ( {H}^{T} H ) s + {H}^{T} n = [ \begin{matrix}{\vert a \vert}^{2} {I}_{2} & C \\ {C}^{*} & {\vert b \vert}^{2} {I}_{2}\end{matrix} ] [ \begin{matrix}{s}_{0} \\ {s}_{1} \\ {s}_{2} \\ {s}_{3}\end{matrix} ] + {H}^{T} n \qquad ( 28 )$$

In some demonstrative embodiments, symbols 866 and 867 may include the symbols s̅ᵢ, s̅ᵢ₊₁, e.g., separately, for i=0 or i=2, assuming the transmission is of four symbols, wherein s̅ᵢ, s̅ᵢ₊₁ may be determined, for example, as follows:

$$\begin{matrix}if {\vert a \vert}^{2} > {\vert b \vert}^{2} & [ \begin{matrix}{\overline{s}}_{2} \\ {\overline{s}}_{3}\end{matrix} ] = \frac{1}{{\vert b \vert}^{2}} ( [ \begin{matrix}{\hat{r}}_{2} \\ {\hat{r}}_{3}\end{matrix} ] - {C}^{*} [ \begin{matrix}{\hat{s}}_{0} \\ {\hat{s}}_{1}\end{matrix} ] ) \\ else & [ \begin{matrix}{\overline{s}}_{0} \\ {\overline{s}}_{1}\end{matrix} ] = \frac{1}{{\vert a \vert}^{2}} ( [ \begin{matrix}{\hat{r}}_{0} \\ {\hat{r}}_{1}\end{matrix} ] - C [ \begin{matrix}{\hat{s}}_{2} \\ {\hat{s}}_{3}\end{matrix} ] )\end{matrix} \qquad ( 29 )$$

According too some demonstrative embodiments, decoder 801 may also include a second set of two or more detectors, e.g., ML detectors 840-1 and 840-2, to receive symbols 867 and 866, respectively; and to generate detected symbols 868 and 869, respectively, corresponding to the pair of the noisier symbols.

In some demonstrative embodiments, decoder 801 may also include a permutation unit 850 to permute detected symbols 864, 865, 868 and 869, e.g., in accordance with control signal 803, in order to provide demapper 660-1 with a symbol of symbols 864, 865, 868 and 869, which corresponds to symbol 603-1; to provide demapper 660-2 with a symbol of symbols 864, 865, 868 and 869, which corresponds to symbol 603-2; to provide demapper 660-3 with a symbol of symbols 864, 865, 868 and 869, which corresponds to symbol 603-3; and to provide demapper 660-4 with a symbol of symbols 864, 865, 868 and 869, which corresponds to symbol 603-4.

In some demonstrative embodiments, receiver 800 may be implemented to provide a reduction of the noise interference, and/or a higher diversity order. Receiver 800 may enable symbol cancellation along with a linear zero-forcing detection. The use of symbol cancellation may allow, for example, the subtraction of interferences from already detected symbols from the received signal vector, which may result in a modified received vector in which fewer interferes are present.

In one demonstrative embodiment, wherein N=4, after attaining H^{T}r, an operation that requires 4*M complex multiplications, only one pair of signals may be required to be retrieved. These two operations may require 4*M+8 complex multiplications, e.g., instead of 4*M+16 for a zero-forcing detector case, or 4*M*256 for a Quadrature-Phase-Shift-Keying (QPSK) implementation that provides a similar transmission rate. Then, the following operation requires only four complex multiplications, i.e. the multiplication with the matrix C. Therefore, the total number of complex multiplications for controller 830 may be 4*M+12, compared to 4*M+8 for a zero-forcing detector. Accordingly, controller 830 may be implemented with less complex multiplications than a zero-forcing detector.

The following table includes a comparison between MIMO transmission wireless implementations:

TABLE 1

| | | High Diversity | High Diversity |
|---|---|---|---|
| | QPSK | 16QAM | 16QAM |
| | (ML detector) | (Zero-forcing) | w/Control Unit |
| Transmitter | Simple | 1 OFDM symbol | 1 OFDM symbol |
| | transmitter | delay | delay |
| Receiver | No delay | 1 OFDM symbol | 1 OFDM symbol |
| | | delay | delay |
| # Tx/Rx | 4/M | 4/M | 4/M |
| Antennas | | | |
| Cost functions | 4 × M × 256 | 4 × M + 16 complex | 4 × M + 12 complex |
| calculation for | complex | multiplications and 4 | multiplications |
| the decision rule | multiplications | divisions of complex | and 4 divisions of |
| [per bin] | (abs(y-Hs)) | numbers by real | complex numbers |
| | | numbers | by real numbers |
| ML detector | Choose between | Simple slicer | Simple slicer |
| | 256 hypothesis | | |

The first column of Table 1 relates to a typical QPSK transmission implementation including a ML detector. The second column relates to a 16 QAM transmission implementation including a zero-forcing detector, in some demonstrative embodiments. The third column relates to a 16 QAM transmission implementation including an interference-cancellation detector, in some demonstrative embodiments.

As shown in Table 1, the use of 16 QAM transmission implementations according to some embodiments may provide a transmission rate of the typical QPSK implementation, while having less complexity at the receiving end, e.g., despite the richer constellation used.

Referring back to FIG. 2, in some embodiments one or more elements of system 200, e.g., transmitter 202 and/or receiver 210, may be adapted to perform decision-directed operation, e.g., as described below.

In some embodiments, transmitter 202 may apply to signals 204 a space-time code, e.g., the space-time code described above or any other suitable space-time code, in conjunction with an antenna permutation scheme. In one example, transmitter 202 may apply the antenna permutation scheme on top of a predefined base space-time block code (STBC), e.g., as described below.

In a “wireline” system, e.g., a system including a source and a destination communicating over a wired connection, which implements decision-directed operation, a decision error probability of different bins (sub-carriers) may be substantially equal, slowly varying and/or controllable. Accordingly, such wireline system may allow lowering an adaptation rate, e.g., such that decision errors will not propagate.

In contrast to the wired connection of the wireline system, wireless communication channels may be dominantly affected by a fading effect. A decision error rate in the wireless communication channels may vary over time (different symbols) and/or over frequency bins (subcarriers), for example, due to the fading effect. The decision error rate of specific bins may be relatively high, thereby preventing, for example, decision directed training. While an error correction code may be used to correct high error rate in some of the bins, e.g., by using reliable bins, the decision directed adaptation, which does not use error correction code, may not correct the high error rate. Therefore, some conventional wireless communication systems, for example, conventional Wimax communication systems, e.g., in accordance with the IEEE 802.16 standards, may implement pilot symbols (“pilots”) to perform channel tracking. However, the transmission utilizing the pilot symbols may be restricted to a reduced available bandwidth for communicating data symbols.

In some embodiments, transmitter 202 and/or receiver 210 may perform “channel-tracking-pilotless communication”, for example, by communicating wireless transmission 208 in the form of a “channel-tracking-pilotless transmission”. The term “channel-tracking-pilotless transmission” as used herein may refer to a wireless transmission, which does not include and/or does not utilize substantially any channel-tracking pilot symbols. The channel-tracking-pilotless transmission, e.g., transmission 208, may be configured, e.g., as described herein, to allow channel tracking and/or channel estimation at a receiver, e.g., at receiver 210, for example, although pilot symbols are not used.

In one embodiment, the channel-tracking-pilotless transmission may include, for example, a Wi-Fi transmission, e.g., in accordance with one or more of the IEEE 802.11 standards. In other embodiments, the channel-tracking-pilotless transmission may include any other suitable wireless transmission.

In some embodiments, transmitter 202 and/or receiver 210 may use the antenna permutation to perform decision-directed adaptation, e.g., with relation to the channel-tracking-pilotless transmission, e.g., in a robust manner, for example, with respect to the wireless channel fading effect, e.g., as described below.

In some embodiments, transmitter 202 and/or receiver 210 may use the antenna permutation to allow speeding up of decision directed tracking in wireless channels, e.g., as described below.

In some embodiments, transmitter 202 and/or receiver 210 may implement an antenna-permuted space-time coding scheme, which may pair (group) a channel from an i-th transmit antenna to a j-th receive antenna with different channels, e.g., for the purpose of data demodulation. Such pairing (grouping) may provide, for example, a largely uncorrelated channel state for the space-time code. Therefore, reliabilities of different pairings (groupings) may be less likely to all “vanish” at once. Some of the pairings (groupings) may likely provide a low decision error rate. As a result, a decision-directed adaptation process may be implemented, for example, with relation to the channel-tracking-pilotless transmission, e.g., even though some pairs (groups) may fail, thus providing diversity to decision directed adaptation process.

In some embodiments, receiver 210 may track a reliability parameter, e.g., Signal-to-Noise-Ratio (SNR) or any other suitable reliability and/or error-related parameter, of one or more antenna pairings (groupings), e.g., of each of the antenna pairing (grouping), for each of the bins; and modify the adaptation rate of each pair (group) of each bin according to the reliability parameter, e.g., as described below.

In some embodiments, allowing the increased diversity to the decision directed adaptation process may result in improved reliability of the decision directed process. For example, each of the antenna pairing (grouping) may provide the decision directed process with another “opportunity” to succeed, and therefore continue convergence. A small number of reliable pairings, e.g., a single reliable pairing (grouping), may be enough to continue tracking the channel.

In some embodiments, receiver 210 may adapt the tracking speed based on the antenna pairing SNR, e.g., to improve the tracking speed. For example, receiver 210 may increase the tracking speed, as the SNR increases. Such adaptation may be less effective if, for example, the antenna permutation is not implemented by transmitter 202 since, if for some bin the SNR is low, then the channel of the bin may not be tracked and therefore “lost”. However, when implementing the antenna permutation on the pairings (groupings) with higher SNR, tracking speed may be increased, e.g., to maximum; while for the pairings (groupings) with lower SNR, the tracking speed may be reduced, e.g., to maintain reliability. As a result, both speed and reliability may be increased.

In some embodiments, transmitter 202 may transmit transmission 208 including a channel-tracking-pilotless transmission. The channel-tracking-pilotless transmission may include symbols of two or more space-time block-encoded symbol streams transmitted via a dynamically permuted set of two or more respective transmit antennas of the plurality of transmit antennas of transmitter 202 such that, for example, during at least first and second consecutive time periods the permuted set of transmit antennas includes at least first and second respective different sets of two or more transmit antennas, e.g., as described in detail below.

In some embodiments, receiver 210 may receive transmission 208 including the channel-tracking-pilotless transmission, and generate output signals 212, for example, while performing channel tracking and/or estimation based on the channel-tracking-pilotless transmission, e.g., as described in detail below.

Reference is made to FIG. 9A, which schematically illustrates a wireless transmitter 900 in accordance with some demonstrative embodiments. In one embodiment, transmitter 900 may perform the functionality of transmitter 202 (FIG. 2).

In some embodiments, transmitter 900 may transmit a channel-tracking-pilotless transmission, which may include symbols of two or more space-time block-encoded symbol streams 909 transmitted via a dynamically permuted set of two or more respective transmit antennas of a plurality of transmit antennas 910, e.g., including four antennas 925, 926, 927 and 928. For example, during at least first and second consecutive time periods the permuted set of transmit antennas includes at least first and second respective different sets of two or more of transmit antennas 910, e.g., as described in detail below.

In some embodiments, transmitter 900 may include a serial-to-parallel (S/P) module 902 to route data components of an input data stream 901 to a plurality of data streams 904, e.g., including N_{DS}>2 data streams.

In one embodiment, data streams 904 may include N_{DS}=2 data streams 981 and 982. For example, data stream 981 may include the symbols S0 and S1, and data stream 982 may include the symbols S2 and S3, e.g., in analogy to the above description with reference to FIGS. 3, 4 and/or 5. In other embodiments, data streams 904 may include any other suitable number of data streams and/or any other suitable arrangement of symbols.

In some embodiments, transmitter 900 may apply to data streams 904 a space-time block code in conjunction with an antenna permutation scheme. In one embodiment, the antenna permutation scheme may be applied on top of a predefined base STBC, e.g., as described below. In other embodiments, the space-time code and the antenna permutation scheme may be applied in any other suitable manner, e.g., in the form of a single combined scheme.

In some embodiments, transmitter 900 may include a space-time encoder 906 to generate a plurality of STBC streams 909 by applying the base STBC to streams 904. The number of STBC streams 909 may include a number of streams equal to or less than the number of transmit antennas 910. The number of STBC streams 909 may correspond to the base STBC, for example, the number of STBC streams 909 may be equal to a size of the base STBC source matrix. For example, STBC streams 909 may include four streams 921, 922, 923 and 924, e.g., if the base STBC includes the source matrix of Equation 1.

In some demonstrative embodiments, the STBC may include the space-time code described above. In one embodiment, the space-time block code may include a 4×M block coding scheme (“the base STBC”) relating to four transmit antennas, e.g., antennas 925, 926, 927 and 928, and having a period of two OFDM symbols. For example, during a first symbol period, a first pair of first and second antennas, denoted ‘0’ and ‘1’, respectively, may be assigned with a first pair of symbols, denoted S0 and S1, respectively; and a second pair of antennas including first and second antennas, denoted ‘2’ and ‘3’, respectively, may be assigned with a second pair of symbols, denoted symbols S2 and S3, respectively. During the second symbol period, e.g., immediately subsequent to the first symbol period, the antenna ‘0’ may be assigned with a negative complex conjugate of symbol S1, e.g., a symbol −S1*; the antenna ‘1’ may be assigned with a complex conjugate of symbol S0, e.g., a symbol S0*; the antenna ‘2’ may be assigned with a negative complex conjugate of the symbol S3, e.g., a symbol −S3*; and the antenna ‘3’ may be assigned with the complex conjugate of the symbol S2, e.g., a symbol S2*, wherein “*” denotes a complex conjugate. For example, the base STBC scheme may be represented by the source matrix of Equation 1, as described above. In another embodiment, the base STBC may include any suitable block-coding scheme relating to any suitable number of two or more transmit antennas having a period of two or more symbols. For example, a transmitter including three or more antennas may apply a suitable antenna permutation to a base STBC including, for example, the conventional 2×M Alamouti coding scheme.

In some embodiments, transmitter 900 may also include an antenna permutation module 907 to sequentially permute symbols of STBC streams 909 to permuted symbol streams 930 according to an antenna permutation scheme, which includes a respective sequence of sets of the plurality of transmit antennas 910, e.g., as described below. In one embodiment, streams 930 may include four streams 931, 932, 933 and 934 corresponding to transmit antennas 925, 926, 927 and 928, respectively. In other embodiments, streams 930 may include any other suitable number of streams, e.g., less than or greater than four, to be assigned and/or transformed to transmit antennas 925, 926, 927 and 928, e.g., as described below with reference to FIG. 9B.

In some embodiments, transmitter 900 may include a permutation sequencer 908 to determine which antenna permutation is to be applied to the STBC streams 909 at each symbol and/or frequency bin and/or to determine a linear transform to be applied to the permuted streams, e.g., as described below.

In some embodiments, transmitter 900 may also include any suitable module, e.g., at least one analog front end 912 to transmit the symbols of permuted streams 930 via antennas 910, respectively.

As described above, the base STBC scheme may relate to two pairs of the four antennas 910. In some embodiments, transmitter 900 may implement an antenna-permuted STBC, which may permute between the pairs of antennas of the base STBC. For example, permutation sequencer 908 may switch between a predefined number of antenna permutations, each including different pairings of the four antennas. In one example, the antenna-permuted STBC may have a period of up to six symbol periods.

In some embodiments, permutation 908 may switch between three different antenna permutations, denoted TX_PERM, during three respective consecutive pairs of symbol periods. In one embodiment, permutation sequencer 908 may apply to streams 909 a first antenna permutation, denoted TX_PERM=a, during the first and second symbol periods; permutation sequencer 908 may apply to streams 909 a second antenna permutation, denoted TX_PERM=b, during the third and fourth symbol periods; and permutation sequencer 908 may apply to streams 909 a third antenna permutation, denoted TX_PERM=c, during the fifth and sixth symbol periods.

In one example, the first antenna permutation may include the identity permutation, such that the base STBC is implemented “as is”, e.g., wherein the first pair of antennas includes antennas ‘1’ and ‘2’, and the second pair of antennas includes the antennas ‘2’ and ‘3’, as described above. For example, antenna permutation module 907 may assign symbols of streams 921, 922, 923 and 924 to streams 931, 932, 933 and 934, respectively.

The second antenna permutation may include mapping the pair of antennas ‘1’ and ‘2’, and the pair of antennas ‘3’ and ‘4’ of the base STBC to the pairs of antennas ‘1’, ‘3’ and ‘2’, ‘4’ respectively. For example, antenna permutation module 907 may assign symbols of streams 921, 922, 923 and 924 to streams 931, 933, 932 and 934, respectively.

The third antenna permutation may include mapping the pair of antennas ‘1’ and ‘2’, and the pair of antennas ‘3’ and ‘4’ of the base STBC to the pairs of antennas ‘1’, ‘4’ and ‘2’, ‘3’ respectively. For example, antenna permutation module 907 may assign symbols of streams 921, 922, 923 and 924 to streams 931, 934, 932 and 933, respectively.

In one embodiment, transmitter 900 may apply the antenna-permuted STBC represented by a source matrix, denoted Sp, e.g., as follows:

$$Sp = [ \begin{matrix}{S}_{0} & - {S}_{1}^{*} & {S}_{4} & - {S}_{5}^{*} & {S}_{8} & - {S}_{9}^{*} \\ {S}_{1} & {S}_{0}^{*} & {S}_{6} & - {S}_{7}^{*} & {S}_{10} & - {S}_{11}^{*} \\ {S}_{2} & - {S}_{3}^{*} & {S}_{5} & {S}_{4}^{*} & {S}_{11} & {S}_{10}^{*} \\ {S}_{3} & {S}_{2}^{*} & {S}_{7} & {S}_{6}^{*} & {S}_{9} & {S}_{8}^{*}\end{matrix} ] \qquad ( 30 )$$

In other embodiments, transmitter 900, antenna permutation module 907 and/or permutation sequencer 908 may implement any other suitable antenna permutations.

In some embodiments, transmitter 900 may also apply different antenna permutations to different frequency bins of the same symbol, for example, to allow an error correction code e.g., as described below, to better utilize the diversity obtained by permuting antennas.

In one embodiment, transmitter 900 may implement the following interleaved antenna permutation scheme:

TABLE 2

| | Frequency Bin Index: | | | | | | |
|---|---|---|---|---|---|---|---|
| Time Index | 1 | 2 | 3 | 4 | 5 | 6 | . . . |
| Symbol periods 1, 2 | a | b | c | a | b | c | |
| Symbol periods 3, 4 | b | c | a | b | c | a | |
| Symbol periods 5, 6 | c | a | b | c | a | b | |
| Symbol periods 1, 2 | a | b | c | a | b | c | |
| . . . | | | | | | | |

Although some demonstrative embodiments are described herein with reference to a demonstrative STBC, e.g., the base space-time coding scheme represented by the source matrix S of Equation 1, in other embodiments any other suitable base STBC may be implemented.

Although some demonstrative embodiments are described herein with reference to a demonstrative 4×M STBC, in other embodiments any other suitable space-time coding scheme may be implemented with reference to any other number N of transmission antennas, e.g., less than or greater than four. In one example, a transmitter with three or more transmission antennas may implement a base STBC suitable for two transmit antennas, e.g., a 2×M Alamouti coding scheme, to encode data signals and generate two streams of signals, which may be selectively switched between the three or more antennas, e.g., using any suitable antenna permutation scheme, such that different pairs of the three or more antennas are selectively used for transmitting the two encoded streams. In another example, a transmitter with three or more transmission antennas to transmit three or more streams, wherein two of the streams are encoded according to a 2×M Alamouti coding scheme. According to this example, the two streams to be encoded may be selected from the three or more streams according to two or more different selection schemes, e.g., such that different streams are selected for different symbols. The transmitter, according to this example, may have an increased an overall transmission rate since, for example, the one or more streams not being encoded according to the Alamouti scheme may have a higher transmission rate. The transmitter, according to this example, may allow the receiver to perform channel tracking during at least part of the transmission, e.g., when the relatively “weak” transmit antennas transmit the Alamouti-encoded streams, and the transmission of relatively “strong” transmit antennas may be demodulated correctly, even if not encoded according to the Alamouti scheme.

In some embodiments a transmitter, e.g., transmitter 900, including an antenna permutation module, e.g., antenna permutation module 907, to permute symbols of STBC streams, e.g., STBC streams 909, to a plurality of permuted streams, e.g., symbol streams 930, including a number of permuted streams equal to a number of transmit antennas, e.g., the number of transmit antenna 910. However, other embodiments may include a transmitter capable of applying any suitable transformation to the output of the antenna permutation module, for example, as shown in FIG. 9B, which schematically illustrates a wireless transmitter 950 in accordance with another demonstrative embodiment.

As shown in FIG. 9B, transmitter 950 may include a transformation module 952 to apply, for example, a linear transformation, e.g., a unitary or non-unitary transformation, to the symbols of permuted streams 930. For example, transformation module 952 may multiply the symbols of permuted streams 930 by a predefined transformation matrix. The transformation applied by transformation module 952 may be configured to allow efficient and/or equal utilization of power amplifiers along transmission paths of front 912.

In one embodiment, the number of transmit antennas 910 is greater than the number of permuted streams 930, for example, transmit antennas 910 include five antennas while permuted streams 930 include four streams. Transformation module 952 may distribute permuted streams 930 to the transmit paths of the plurality of transmit antennas 910, e.g., in order to avoid utilizing only some of the power amplifiers. For example, transformation module 952 may apply a 4×5 transformation matrix to distribute the four permuted streams 930 to five transmit antennas 910.

In some embodiments, the transformation applied by transformation module 952 may optionally allow applying an additional antenna permutation to permuted streams 930, e.g., by adding one or more “virtual” antennas that are a unitary transform of the physical transmit antennas 910 and additional permutations that switch between sets of virtual and physical antennas. In one embodiment, permutation sequencer 908 may control transformation module 952 to apply one or more suitable transformations determined by sequencer 908.

Reference is made to FIG. 10, which schematically illustrates a wireless receiver 1000, in accordance with some demonstrative embodiments. In one embodiment, receiver 1000 may perform the functionality of receiver 210 (FIG. 2).

In some embodiments, receiver 1000 may receive a wireless transmission, e.g., including the channel-tracking-pilotless wireless transmission transmitted by transmitter 900 (FIG. 9A) via a plurality of receive antennas 1002. Receiver 1000 may be capable of generating an output 1025, e.g., including output 212 (FIG. 2), including data based on the channel-tracking-pilotless wireless transmission.

In some embodiments, receiver 1000 may also include any suitable module, e.g., at least one analog front end 1004, to generate a plurality of signals 1006 corresponding to the signals of the wireless transmission received via antennas 1002, respectively. For example, signals 1006 may include any suitable time-domain signals corresponding to the channel-tracking-pilotless wireless transmission.

In some embodiments, receiver 1000 may include any suitable one or more modules to generate a plurality of frequency domain signals 1010, e.g., including four sets of frequency domain signals 1011, 1012, 1013, and 1014, corresponding to signals 1006. For example, signals 1010 may include N_{BIN}*N_{RX} signals, e.g., such that each of sets 1011, 1012, 1013 and 1014 includes N_{BIN} signals, wherein N_{BIN} denotes the number of frequency bins, and wherein N_{RX} denotes the number of receive antennas 1002. For example, receiver 1000 may include at least one module 1008 to perform suitable automatic-gain-control (AGC), DC cancellation, decimation, time-frequency correction, I-Q imbalance, and/or match filter operations.

In some embodiments, receiver 1000 may also include a STBC decoder 1016 to generate a plurality of data streams 1018 by applying to signals 1010 an inverse antenna-permuted STBC scheme, e.g., an inverse of the antenna permuted STBC scheme applied by transmitter 900 (FIG. 9A), as described in detail below. For example, streams 1018 may include a number of streams, e.g., N_{BIN}*N_{DS} streams, corresponding to the number of data streams 904 (FIG. 9A). In one example, streams 1018 may include two sets of streams 1019 and 1020, e.g., each including N_{BIN} data component streams.

In some embodiments, STBC decoder 1016 may apply to signals 1010 of the plurality of frequency bins a respective plurality of per-bin antenna permuted channel responses, e.g., in the form of permuted channel matrices 1062, denoted H(:,RxPerm). For example, STBC decoder 1016 may apply to the N_{BIN} frequency bins of signals 1010 N_{BIN} respective antenna permuted channel matrices 1062.

In some embodiments, a permuted matrix H(:,RxPerm) corresponding to a frequency bin may include a column-wise permutation, denoted RxPerm, of a channel estimation matrix, denoted H, corresponding to the frequency bin. The matrix H may include a number of rows equal to the number N_{RX} of receive antennas 1002, and a number of columns, denoted N_{TX}, equal to the number of transmit antennas 910 (FIG. 9A). Although some embodiments are described herein with reference to using a channel matrix and/or a permuted channel matrix, e.g., matrices 1062 and/or H, to represent a channel response, other embodiments may be implemented using any other representation of the channel response, e.g., in any form other than a channel matrix.

In some embodiments, receiver 1000 may include any suitable memory or buffer 1056 to maintain the N_{BIN} matrices H corresponding to the plurality of frequency bins; a permutation sequencer 1042 to generate a sequence of antenna permutation signals 1044; and a permutation module 1058 to apply to the matrix H a column-wise permutation according to permutation signals 1044, e.g., as described below. For example, signals 1044 may include an index of an antenna permutation to be applied by permutation module 1058.

In some embodiments, the permutation RxPerm may include an inverse of the antenna permutation applied by transmitter 900 (FIG. 9A). In one embodiment, permutation sequencer 1042 may implement the following inverse permutation, e.g., to decode the antenna permutation described above with reference to FIG. 9A. For TX_PERM=a, the RX antenna permutation, denoted RX_PERM=a, may include the identity permutation that uses the base STBC as is, e.g., permutation sequencer 1042 may generate signal 1044 representing the identity permutation is to be applied to the matrix H. For TX_PERM=b, the RX Antenna permutation, denoted RX_PERM=b, of signal 1044 may include a permutation mapping the columns 1,3 and 2,4 of the matrix H to the columns 1,2 and 3,4 of matrix H(;,RxPerm). For TX_PERM=c, the RX Antenna permutation, denoted RX_PERM=c, of signal 1044 may include a permutation mapping the columns 1,4 and 2,3 of the matrix H to the columns 1, 2, and 3, 4 of matrix H(:,RxPerm).

In some embodiments, receiver 1000 may include a parallel-to-serial (P/S) module 1022 to route data components of streams 1018 to a single stream of 1023, and a suitable decoder 1024 to generate output 1025 by decoding the data of stream 1023 according to any suitable wireless decoding scheme.

In some embodiments, receiver 1000 may be capable of performing channel tracking and/or adapting the channel matrices H corresponding to the communication channels between receive antennas 1002 and transmit antennas 910 (FIG. 9A), based on the channel-tracking-pilotless transmission.

In some embodiments, receiver 1000 may use the antenna permutations applied by transmitter 900 (FIG. 9A) to allow speeding up of decision directed tracking in the wireless channels, e.g., as described below.

In some embodiments, receiver 1000 may be capable of performing decision-directed adaptation of one or more of the channel matrices H, e.g., all of the matrices, based on one or more decision-related parameters corresponding to signals 1018, e.g., as described below.

As described above, the antenna-permuted space-time coding scheme applied to the wireless transmission received by receiver 1000 may pair (group) a channel from an i-th transmit antenna to a j-th receive antenna with different channels, e.g., for the purpose of data demodulation as described herein. Such pairing (grouping) may provide, for example, a largely uncorrelated channel state for the space-time code. Therefore, reliabilities of different pairings (groupings) may be less likely to all “vanish” at once. Some of the pairings (groupings) may likely provide a low decision error rate. As a result, receiver 1000 may implement a decision-directed adaptation process, for example, with relation to the received transmission, e.g., even though some pairs (groups) may fail, thus providing diversity to decision directed adaptation process.

In some embodiments, receiver 1000 may track a reliability parameter, e.g., Signal-to-Noise-Ratio (SNR), of one or more antenna pairings (groupings), e.g., of each of the antenna pairing (grouping), for each of the N_{BIN} frequency bins; and modify the adaptation rate of each pair (group) of each bin according to the reliability parameter, e.g., as described below.

In some embodiments, allowing the increased diversity to the decision directed adaptation process may result in improved reliability of the decision directed process. For example, each of the antenna pairing (grouping) may provide the decision directed process with another “opportunity” to succeed, and therefore continue convergence. A small number of reliable pairings, e.g., a single reliable pairing (grouping), may be enough to continue tracking the channel.

In some embodiments, receiver 1000 may adapt the tracking speed based on the antenna pairing SNR, e.g., to improve the tracking speed. For example, receiver 1000 may increase the tracking speed, as the SNR increases. Such adaptation may be less effective if, for example, the antenna permutation is not implemented by transmitter 900 (FIG. 9A) since, if for some bin the SNR is low, then the channel of the bin may not be tracked and therefore “lost”. However, when implementing the antenna permutation on the pairings (groupings) with higher SNR, tracking speed may be increased, e.g., to maximum; while for the pairings (groupings) with lower SNR the tracking speed may be reduced, e.g., to maintain reliability. As a result, both speed and reliability may be increased.

In some embodiments, receiver 1000 may include at least one decision-related module, e.g., a slicer 1026, to generate a plurality of decisions 1030 corresponding to the data components of streams 1018; and a plurality of decision errors 1028 corresponding to th plurality of decisions 1030. For example, slicer 1026 may generate N_{BIN}*N_{DS} decisions, denoted X_{NBIN*NDS}, and N_{BIN}*N_{DS} decision errors, denoted E_{NBIN*NDS}, corresponding to the N_{BIN}*N_{DS} streams 1018, respectively. For example, decisions 1030 may include N_{DS} decisions corresponding to each of the N_{BIN} frequency bins. Each of the decisions 1030 may include, for example, a potential symbol, which is potentially represented by a respective signal of signals 1018. Each of the decision errors 1028 may include, for example, an error between the potential symbol and the respective signal of signals 1018. In other embodiments, receiver 1000 may include any other decision-related module, in addition to or instead of slicer 1026, for example, one or more modules of a decoding path and/or an error-correction-code path.

In some embodiments, receiver 1000 may also include an averaging module 1034 to apply a predefined averaging function to the decision errors 1028 of a frequency bin corresponding to a certain antenna permutation and a certain frequency bin (“the certain permutation-bin combination”). In one embodiment, the averaging function may include a mean square averaging function to determine the mean square decision error, denoted SLICER_MSE_{NBIN×NDS×NPERM}, per frequency bin (N_{BINS}), data stream (N_{DS}), and/or permutation (N_{PERM}). For example, different frequency bins may have different SLICER_MSE values, e.g., due to channel frequency selectivity; different data streams may have different SLICER_MSE values, e.g., due to the communication channel being “stronger” in certain directions and weaker in others; and/or different antenna permutations may have different SLICER_MSE values, e.g., since some permutations may be better balanced than others in term of noise inflicted on different STBC pairs. In other embodiments, the averaging function may include any other suitable function.

In some embodiments, receiver 1000 may perform the channel tracking based on a stochastic gradient decent algorithm, for example, a Least-Mean-Squares (LMS) algorithm, e.g., as described below. In other embodiments, any other suitable channel tracking mechanism, algorithm and/or method may be implemented.

In some embodiments, receiver 1000 may include a correction-step determination module 1038 to determine a varying correction step, denoted μ, to be used by the LMS algorithm. For example, module 1038 may determine the correction step μ corresponding to the certain permutation-bin combination. Receiver 100 may correct the matrix H corresponding to the certain frequency bin based on the decisions of the different antenna permutations with relation to the specific frequency bin, e.g., as described below.

In some embodiments, module 1038 may determine the value of μ corresponding to the certain permutation-bin combination based, for example, on the SLICER_MSE values corresponding to the certain permutation-bin combination. In one embodiment, module 1038 may determine the value of μ inversely proportional to the SLICER_MSE values. For example, module 1038 may determine a relatively large correction step μ for relatively small SLICER_MSE values, to enable relatively fast tracking since, for example, decision errors are not likely. Module 1038 may determine a relatively low correction step μ for relatively large SLICER_MSE values, to enable relatively slow tracking in order, for example, to prevent wrong tracking corrections, which may result in a bad channel estimation, and therefore cause error propagation. In some embodiments, module 1038 may determine a correction step μ substantially equal to zero for very large SLICER_MSE values, such that tracking may not be performed since, for example, decision errors are too likely. In all cases when applying the slow or zero tracking, it is expected that in other antenna permutations tracking may be performed at normal speed or faster.

In some embodiments, receiver 1000 may also include a multiplication module 1032 to determine a product, denote HX, of a vector, denoted X_{NTX}, of decisions 1030 and the permuted matrix H(:,RX_PERM). Receiver 1000 may also include a subtraction module to determine an input prediction error vector, denoted Err_{NRX}, corresponding to the certain permutation-bin combination, by subtracting the product HX from a vector, denoted, Y, of signals 1010 corresponding to the decisions vector X_{NTX}.

In some embodiments, receiver 1000 may also include a channel adaptation module 1046 to determine an adaptation matrix, denoted dH_{NRX*NTX}, to be applied to the channel matrix H corresponding to the certain bin based on the values of the input prediction error vector Err_{NRX}, the correction step μ, and the decisions vector X_{NTX} corresponding to the certain permutation-bin combination. For example, module 1046 may determine the adaptation matrix as follows:

dH=μ·Err_{NRX}·X^{H} (31)

wherein X^{H} denotes a 1×N_{TX} vector including a transpose conjugate of the decisions vector X_{NTX}, e.g., conj(X).

In some embodiments, receiver 1000 may adapt the channel matrix H corresponding to a certain frequency bin based on a plurality of the adaptation matrices corresponding to the plurality of combinations of the plurality of antenna permutations and the certain frequency bin. For example, receiver 1000 may iteratively add the adaptation matrices dH resulting from the three antenna permutations with relation to the certain frequency bin to the channel matrix stored in memory 1056. As a result, the matrix H corresponding to the certain frequency bin may be updated based on a weighted sum of the values Err_{NRX}·X^{H} corresponding to the different antenna permutations, according to the weight of μ.

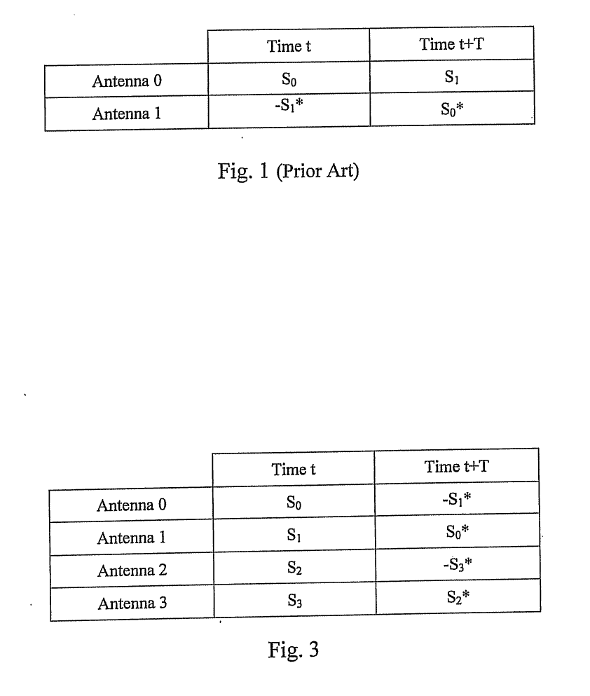

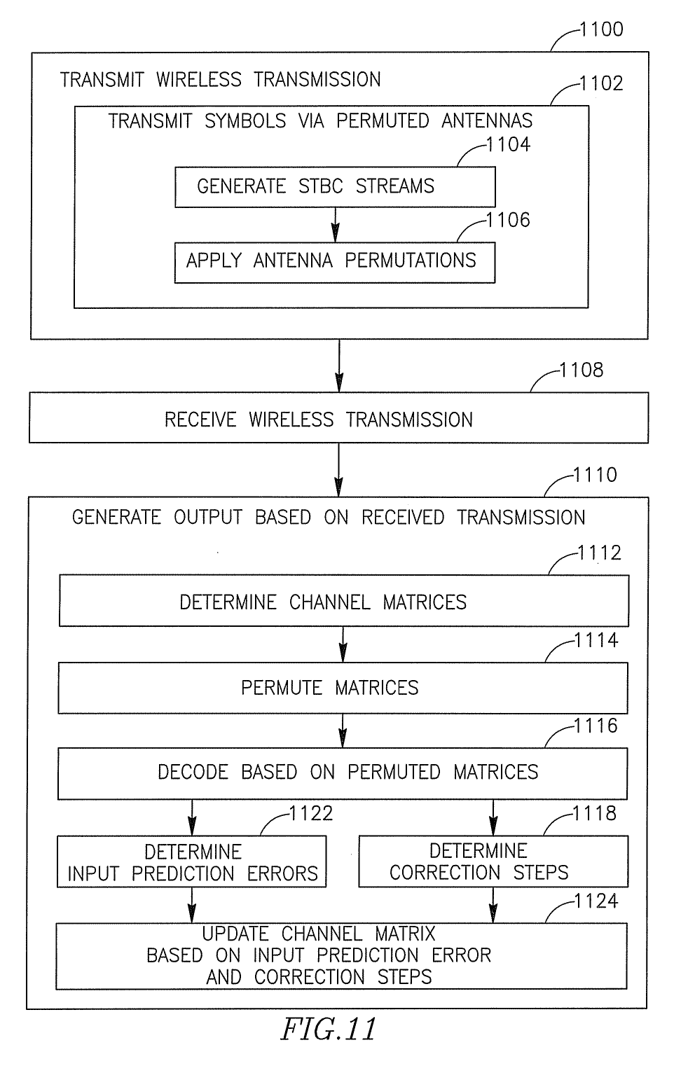

Reference is made to FIG. 11, which schematically illustrates a method of wireless communication, in accordance with some demonstrative embodiments. In one embodiment, on or more operations of the method of FIG. 11 may be performed by one or more elements of a communication system, e.g., system 200 (FIG. 2), a transmitter, e.g., transmitter 900 (FIG. 9A), and/or a receiver, e.g., receiver 1000 (FIG. 1).

As indicated at block 1100, the method may include transmitting a wireless transmission via a plurality of antennas. In some embodiments, the wireless transmission may include, for example, a channel-tracking-pilotless transmission, e.g., as described above. In other embodiments, the wireless transmission may include any other suitable transmission.

As indicated at block, 1102, transmitting the transmission may include transmitting symbols of two or more space-time block-encoded streams via a sequentially permuted set of two or more respective transmit antennas of the plurality of transmit antennas. During at least first and second consecutive time periods the permuted set of transmit antennas may include at least first and second respective different sets of two or more transmit antennas. For example, transmitter 900 (FIG. 9A) may transmit the wireless transmission, e.g., as described above.

As indicated at block 1104, the method may include generating the two or more space-time block-encoded streams by encoding data symbols according to a base space-time block-coding scheme. For example, encoder 906 (FIG. 9A) may encode the data f streams 904 (FIG. 9A), e.g., as described above.

As indicated at block 1106, the method may include applying a sequence of at least first and second antenna permutations to permute the symbols of the two or more space-time block-encoded symbol streams to the at least first and second different sets of two or more transmit antennas. For example, permutation module 907 (FIG. 9A) may apply the antenna permutations to the encoded streams, e.g., as described above.

As indicated at block 1108, the method may include receiving the wireless transmission via a plurality of receive antennas. For example, receiver 1000 (FIG. 10) may receive the wireless transmission via antennas 1002 (FIG. 10), as described above.

As indicated at block 1110, the method may include generating an output including data based on the received wireless transmission. For example, receiver 1000 (FIG. 1) may generate output 1025 (FIG. 10), e.g., as described above.

As indicated at block 1112, the method may include determining a plurality of channel matrices corresponding to a plurality of frequency bins, respectively, based on the received channel-tracking-pilotless wireless transmission. For example, receiver 1000 (FIG. 10) may determine the matrices H corresponding to the plurality of frequency bins, e.g., as described above.

As indicated at block 1114, the method may include for at least one frequency bin, determining at least first and second permuted matrices by permuting the channel matrix corresponding to the frequency bin according to at least first and second antenna permutations, respectively. For example, permutation module 1058 (FIG. 10) may apply the inverse antenna permutations, e.g., as described above.

As indicated at bock 1116, the method may include decoding symbols of the frequency bin based on the permuted channel matrices. For example, decoder 1016 (FIG. 10) may decode the symbols of streams 1010 (FIG. 10) based on the permuted matrices, e.g., as described above.

As indicated at block 1118, the method may include determining at least first and second correction steps corresponding to the at least first and second antenna permutations, respectively, based on decision errors of decisions corresponding to the decoded symbols. For example, module 1035 (FIG. 10) may determine the correction steps μ, e.g., as described above. For example, the correction step may be inversely proportional to a means square error of the decisions, e.g., as described above.

As indicated at block 1122, the method may include determining input prediction errors based on the channel matrix and the decisions. For example, module 1050 (FIG. 10) may determine the input prediction error, e.g., as described above.

As indicated at block 1124, the method may include updating the channel matrix based on the correction step and the input prediction error. For example, module 1046 (FIG. 10) may update the matrix H stored in memory 1056 (FIG. 10) based on the correction step and the input prediction error, e.g., as described above.

Some embodiments, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), a rigid magnetic disk, and an optical disk. Some demonstrative examples of optical disks include compact disk-read only memory (CD-ROM), compact disk-read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Functions, operations, components and/or features described herein with reference to one or more embodiments, may be combined with, or may be utilized in combination with, one or more other functions, operations, components and/or features described herein with reference to one or more other embodiments, or vice versa.

While certain features of embodiments of the invention have been illustrated and described herein, many modifications, substitutions, changes, and equivalents may occur to those skilled in the art. It is, therefore, to be understood that the appended claims are intended to cover

What is claimed is:

1. A wireless communication system including:
a receiver to receive a wireless transmission via a plurality of receive antennas, and to generate an output including data based on the received wireless transmission, the receiver including:
a decoder to decode symbols of at least one frequency bin based on at least first and second antenna permutations applied to at least one channel response corresponding to the frequency bin;
a correction-step determination module to determine at least first and second correction steps corresponding to the at least first and second antenna permutations, respectively, based on decision errors of decisions corresponding to the decoded symbols; and
a channel adaptation module to update the channel response based on the correction steps.

2. The system of claim 1, wherein the receiver comprises:
a memory to store a plurality of channel responses corresponding to a plurality of frequency bins, respectively; and
a permutation module to determine, for the at least one frequency bin, at least first and second permuted channel responses, by permuting the channel response corresponding to the frequency bin according to the at least first and second antenna permutations, respectively,
wherein the decoder is to decode the symbols of the frequency bin based on the permuted channel matrices.

3. The system of claim 1, wherein the correction steps are inversely proportional to a means square error of the decisions.

4. The system of claim 1, wherein the receiver is to determine input prediction errors based on the channel response and the decisions, and wherein the channel adaptation module is to update the channel response based on the correction steps and the input prediction errors.

5. The system of claim 1, wherein the wireless transmission includes a channel-tracking-pilotless transmission.

6. The system of claim 1, wherein the transmission includes symbols of two or more space-time block-encoded streams transmitted via a sequentially permuted set of two or more respective transmit antennas of a plurality of transmit antennas, and
wherein during at least first and second consecutive time periods the permuted set of transmit antennas includes at least first and second respective different sets of two or more transmit antennas.

7. A method of performing multi-input-multi-output (MIMO) wireless communication, the method comprising:
transmitting a wireless transmission, which does not include channel-tracking-pilot symbols, via a plurality of transmit antennas,
wherein transmitting the transmission includes transmitting symbols of two or more space-time block-encoded streams via a sequentially permuted set of two or more respective transmit antennas of the plurality of transmit antennas, and
wherein during at least first and second consecutive time periods the permuted set of transmit antennas includes at least first and second respective different sets of two or more transmit antennas.

8. The method of claim 7 comprising:
generating the two or more space-time block-encoded streams by encoding data symbols according to a base space-time block-coding scheme; and
applying a sequence of at least first and second antenna permutations to permute the symbols of the two or more space-time block-encoded symbol streams to the at least first and second different sets of two or more transmit antennas.

9. The method of claim 7 comprising:
receiving the wireless transmission via a plurality of receive antennas; and
generating an output including data based on the wireless transmission.

10. The method of claim 9 comprising:
decoding symbols of at least one frequency bin based on at least first and second antenna permutations applied to at least one channel response corresponding to the frequency bin.

11. The method of claim 10 including:
determining a plurality of channel responses corresponding to a plurality of frequency bins, respectively, based on the received wireless transmission; and
for the at least one frequency bin, determining at least first and second permuted channel responses by permuting the channel response corresponding to the frequency bin according to the at least first and second antenna permutations, respectively,
wherein decoding the symbols includes decoding the symbols of the frequency bin based on the permuted channel matrices.

12. The method of claim 10 comprising:
determining at least first and second correction steps corresponding to the at least first and second antenna permutations, respectively, based on decision errors of decisions corresponding to the decoded symbols; and
updating the channel response based on the correction steps.

13. The method of claim 12, wherein the correction steps are inversely proportional to a means square error of the decisions.

14. The method of claim 7 comprising:
determining input prediction errors based on the channel response and the decisions; and
updating the channel response based on the correction steps and the input prediction errors.

15. The method of claim 7, wherein the two or more space-time block-encoded streams include a plurality of pairs of space-time block-encoded streams,
wherein said plurality of pairs of space-time block-encoded streams represent a plurality of different pairs of symbols, respectively,
wherein during a first symbol time period each of said pairs of streams includes a first pair of symbols, respectively, and
wherein during a second symbol time period each of said pairs of streams includes a second pair of symbols corresponding to complex conjugates of said first pair of symbols.

16. The method of claim 15, wherein during said symbol first time period first and second streams of a pair of said plurality of pairs of streams include first and second symbols, respectively, and
wherein during said second symbol time period said first and second streams include a negative conjugate of said second symbol and a conjugate of said first symbol, respectively.

17. The method of claim 7, wherein the plurality of transmit antennas include at least four transmit antennas.

18. The method of claim 7, wherein the at least first and second different sets of two or more transmit antennas include six different sets of four transmit antennas.

19. A wireless communication system including;
a wireless transmitter to transmit a wireless transmission, which does not include channel-tracking pilot symbols, via a plurality of transmit antennas,
wherein the transmission includes symbols of two or more space-time block-encoded streams transmitted via a sequentially permuted set of two or more respective transmit antennas of the plurality of transmit antennas, and
wherein during at least first and second consecutive time periods the permuted set of transmit antennas includes at least first and second respective different sets of two or more transmit antennas.

20. The system of claim 19, wherein the transmitter includes:
a space-time block-encoder to generate the two or more space-time block-encoded streams by encoding data symbols according to a base space-time block-coding scheme; and
an antenna permutation module to apply a sequence of at least first and second antenna permutations to permute the symbols of the two or more space-time block-encoded symbol streams to the at least first and second different sets of two or more transmit antennas.

21. The system of claim 19 comprising:
a receiver to receive the wireless transmission via a plurality of receive antennas, and to generate an output including data based on the wireless transmission.

22. The system of claim 21, wherein the receiver is to decode symbols of at least one frequency bin based on at least first and second antenna permutations applied to at least one channel response corresponding to the frequency bin.

23. The system of claim 22, wherein the receiver is to determine a plurality of channel responses corresponding to a plurality of frequency bins, respectively, based on the received wireless transmission; for the at least one frequency bin, to determine at least first and second permuted channel responses by permuting the channel response corresponding to the frequency bin according to the at least first and second antenna permutations, respectively; and to decode the symbols of the frequency bin based on the permuted channel matrices.

24. The system of claim 22, wherein the receiver includes:
a correction-step determination module to determine at least first and second correction steps corresponding to the at least first and second antenna permutations, respectively, based on decision errors of decisions corresponding to the decoded symbols; and
a channel adaptation module to update the channel response based on the correction steps.

25. The system of claim 24, wherein the correction steps are inversely proportional to a means square error of the decisions.

26. The system of claim 24, wherein the receiver is to determine input prediction errors based on the channel response and the decisions, and wherein the channel adaptation module is to update the channel response based on the correction step and the input prediction errors.

27. The system of claim 19, wherein the two or more space-time block-encoded streams include a plurality of pairs of space-time block-encoded streams,
wherein said plurality of pairs of space-time block-encoded streams represent a plurality of different pairs of symbols, respectively,
wherein during a first symbol time period each of said pairs of streams includes a first pair of symbols, respectively, and
wherein during a second symbol time period each of said pairs of streams includes a second pair of symbols corresponding to complex conjugates of said first pair of symbols.

28. The system of claim 27, wherein during said symbol first time period first and second streams of a pair of said plurality of pairs of streams include first and second symbols, respectively, and
wherein during said second symbol time period said first and second streams include a negative conjugate of said second symbol and a conjugate of said first symbol, respectively.

29. The system of claim 19, wherein the plurality of transmit antennas include at least four transmit antennas.

30. The system of claim 19, wherein the at least first and second different sets of two or more transmit antennas include six different sets of four transmit antennas.
